(19) United States
(12) Patent Application Publication
(10) Pub. No.: US 2010/0211517 A1
(43) Pub. Date: Aug. 19, 2010

(54) VISIT FEASIBILITY USING SCHEDULED TRANSPORT WITHIN A NETWORK OF CONNECTED NODES

(75) Inventor: Michael Haddy, Southern Australia (AU)

Correspondence Address: CALFEE HALTER & GRISWOLD, LLP, 800 SUPERIOR AVENUE, SUITE 1400, CLEVELAND, OH, 44114, US

(73) Assignee: INNOVATION SCIENCE PTY. LTD

(21) Appl. No.: 12/667,289

(22) PCT Filed: Jul. 4, 2008
(86) PCT No.: PCT/AU08/00982

§ 371 Date: May 7, 2010

(30) Foreign Application Priority Data
Jul. 4, 2007 (AU) 2007903611

(51) Int. Cl. G06Q 50/00

(52) U.S. Cl. 705/333

(57) ABSTRACT

Object transportation networks may comprise a network of nodes joined by paths in which transportation means may transport objects between the nodes of the network. In some networks, objects are not actively tracked, and thus may only be detected at specific points (such as entries or exits) In such networks we may be interested in knowing whether it is feasible for an object at one location to be transported to another location within a given time frame. In some circumstances we may have a location of interest and time period of interest. We may then be interested in knowing for other locations in the network, the time period during which it was possible to be transported to the location interest during the time period of interest. We may also be interested in knowing the time period during which it was possible to have been at the location of interest during the time point of interest, and have then been transported to another time location in the network. In some cases we may be interested in whether it is possible to have been at the location of interest for the entire duration of the time period of interest. If we have information on locations and times of objects in the network (such as entry location, entry time, and exit location and exit time) then we can further determine which objects could have been at the location of interest during the time period of interest. Various methods are described for performing such queries, and systems for implementing the methods are discussed.

### CLAIM OF PRIORITY

The present application for patent claims priority from Australian Provisional Patent Application No. 2007903611 entitled “VISIT FEASIBILITY USING SCHEDULED TRANSPORT WITHIN A NETWORK OF CONNECTED NODES”, filed 4 Jul. 2007, which is hereby expressly incorporated by reference herein in its entirety.

### FIELD OF THE INVENTION

The present invention relates to object transportation networks, and in one particular form relates to determining the subset of the objects transported by the network which could have been at a predetermined location during a predetermined time period.

### BACKGROUND OF THE INVENTION

Not all systems for transporting objects have tracking facilities for determining and maintaining the location of each object that enters and leaves the system and those that do have such facilities are not always adequately robust. This is particularly so in relation to an object that is not amenable to tagging or other such means for identifying and tracking their movement through the network, even though those objects are known to be in the network.

Furthermore, not all locations in a network can be equipped to monitor the location of objects, so there are many opportunities during the transit of an object within the system for objects to go missing or be diverted without knowing where the object is or has been. Yet further, even when an object has been tracked for part of its travel within the system, there are difficulties after the tracking device becomes disassociated with the object or is damaged, or one or more tracking sensors are missing or damaged. If the object becomes lost or its history of movement is important, its whereabouts or at least an indication of the likelihood of where it could be or could have been is useful.

Additionally, if objects are afforded autonomous behaviour within the network, each object's whereabouts at any given time (past or present) is substantially influenced by the object itself and thus tracking autonomous objects without the benefit of external knowledge of each object's intended route, can be onerous—particularly when the number of objects within the network is large.

### SUMMARY OF THE INVENTION

According to a first aspect of the present invention, there is provided a method for determining, in an object transportation network having one or more transportation means that transport at discernible times zero, one or more objects between nodes of the network via paths joining adjacent nodes of the network, the subset of the one or more objects that could have been at a predetermined location during a predetermined time period, the method including the steps of:
a) determining for each node of the network, the time period during which an object could have been transported to the predetermined location from the node, wherein said transportation occurred prior to or during the predetermined time period;
b) determining for each node of the network, the time period during which an object could have been transported from the predetermined location to the node, wherein said transportation occurred during or after the predetermined time period; and
c) determining the subset of the one or more objects that could have been at the predetermined location during the predetermined time period wherein if:
an object was at a node during a time period defined by the method steps a) or b) for the node; or
an object was on a transportation means and was transported to or from a node during a time period defined by the method steps a) or b) for the node;
   then the object is a member of the subset of objects that could have been at the predetermined location during the predetermined time period.

According to a second aspect of the present invention, there is provided a method for determining, in an object transportation network having one or more transportation means that transport at discernible times zero, one or more objects between nodes of the network via paths joining adjacent nodes of the network, the subset of the one or more objects that could have been at a predetermined location during a predetermined time period, the method including the steps of:
a) determining for each transportation means in the network, the time period during which an object on the transportation means could have been transported to the predetermined location by one or more transportation means, wherein said transportation occurred prior to or during the predetermined time period;
b) determining for each transportation means in the network, the time period during which an object could have been transported from the predetermined location to the transportation means by one or more transportation means, wherein said transportation occurred during or after the predetermined time period; and
c) determining the subset of the one or more objects that could have been at the predetermined location during the predetermined time period, wherein if:
an object was detected at a node that a transportation means arrived at, or departed from, during a time period defined by the method steps a) or b) for the transportation means; or
an objected was detected on a transportation means during a time period defined by the method steps a) or b) for the transportation means;
   then the object is a member of the subset of objects that could have been at the predetermined location during the predetermined time period.

According to a third aspect of the present invention, there is provided a method for determining, in an object transportation network having one or more transportation means that transport at discernible times zero, one or more objects between nodes of the network via paths joining adjacent nodes of the network, the subset of the one or more objects that could have been at a predetermined location during a predetermined time period, the method including the steps of:
a) associating one or more nodes with the predetermined location
b) associating at least one detection location and detection time period with each object detected entering, exiting or in the network;
c) associating a set of times with a node, wherein the set of times includes a reference time and the latest possible time that an object could have departed each other node in the network and arrived at the node by the reference time, and wherein zero, one or more sets of times are associated with each node of the network; and
d) determining the subset of the one or more objects that could have been at the predetermined location during the predetermined time period wherein if,
at least one associated detection location and time period for the object and at least one of the zero, one or more sets of times associated with each node in the network permit the object to be transported to or from the one or more nodes associated with the predetermined location, said transportation to occurring prior to or during the predetermined time period, and said transportation from occurring during or after the predetermined time period
   then the object is a member of the subset of objects that could have been at the predetermined location during the predetermined time period.

According to a fourth aspect of the present invention, there is provided a method for determining, in an object transportation network having one or more transportation means that transport at discernible times zero, one or more objects between nodes of the network via paths joining adjacent nodes of the network, the subset of the one or more objects that could have been at a predetermined location during the entire duration of the predetermined time period, the method including the steps of:
a) associating one or more nodes with the predetermined location
b) associating at least one detection location and detection time period with each object detected entering, exiting or in the network;
c) associating a set of times with a node, wherein the set of times includes a reference time and the latest possible time that an object could have departed each other node in the network and arrived at the node by the reference time, and wherein zero, one or more sets of times are associated with each node of the network; and
   d) determining the subset of the one or more objects that could have been at the predetermined location during the predetermined time period wherein an object is a member of the subset of objects that could have been at the predetermined location during the predetermined time period if at least one associated detection location and time period for the object and at least one of the zero, one or more sets of times associated with each node in the network permit the object to be transported to one of the one or more nodes associated with the predetermined location, said transportation to occurring prior to or equal to the start of predetermined time period and permit the object to be transported from the node and said transportation from occurring at or after the end of the predetermined period.

According to a fifth aspect of the present invention, there is provided a method for determining, in an object transportation network having one or more transportation means that transport at discernible times zero, one or more objects between nodes of the network via paths joining adjacent nodes of the network, the subset of the one or more objects detected in the network that could have been at a predetermined location during a predetermined time period, the method including the steps of:
a) associating a journey with each object detected in the network, wherein the journey includes a entry location and associated entry time, and a exit location and associated exit time, and a entry node is associated with the entry location and an exit node is associated with the exit location; and
b) associating zero, one or more sets of times with each node of the network, wherein each set of times associated with a node of the network includes the latest possible time that an object could have departed each other node in the network and arrived at the associated node by an associated reference time;
c) associating a node with the predetermined location;
d) determining the subset of the one or more objects that could have been at the predetermined location during the predetermined time period wherein an object is a member of the subset of objects that could have been at the predetermined location during the predetermined time period if,
for each journey associated with an object, the associated entry time of an object is equal to or prior the time corresponding to the associated entry node in the set of times associated with the predetermined location having a reference time closest in time prior or equal to the end of the predetermined time; or
   the start of the predetermined period is greater than or equal to the time corresponding to the node associated with the predetermined location in the set of times associated with the exit node having a reference time closest in time prior or equal to associated exit time.

According to a seventh aspect of the present invention, there is provided a method for determining, in an object transportation network having one or more transportation means that transport at discernible times zero, one or more objects between nodes of the network via paths joining adjacent nodes of the network, the subset of the one or more objects detected in the network that could have been at a predetermined location during a predetermined time period, the method including the steps of:
a) associating a journey with each object detected in the network, wherein the journey includes a entry location and associated entry time, and a exit location and associated exit time, and a entry node is associated with the entry location and an exit node is associated with the exit location; and
b) associating zero, one or more sets of times with each node of the network, wherein each set of times associated with a node of the network includes the earliest possible time that an object could have arrived at each other node in the network having departed the associated node by an associated reference time;
c) associating a node with the predetermined location;
d) determining the subset of the one or more objects that could have been at the predetermined location during the predetermined time period wherein an object is a member of the subset of objects that could have been at the predetermined location during the predetermined time period if,
for each journey associated with an object, the associated exit time of an object is equal to or after the time corresponding to the associated entry node in the set of times associated with the predetermined location having a reference time closest in time equal to or after the start of the predetermined time; or the end of the predetermined period is greater than or equal to the time corresponding to the node associated with the predetermined location in the set of times associated with the entry node having a reference time closest in time equal to after the associated entry time.

According to a eighth aspect of the present invention, there is provided a method for determining, in an object transportation network having one or more transportation means that at discernable times, transport zero or more objects along paths between nodes of the network, the subset of the zero or more objects detected entering, exiting or in the network that could have been at a predetermined location at any time during a predetermined time period, the method including the steps of:
associating zero or more sets of times with each node in the network wherein each set of times includes a reference time and the latest possible time that an object could have departed each other node in the network and arrived at the node by the reference time; and
associating with each object detected in the network, one or more detection locations and associated detection time periods; and
associating one or more nodes with each detected and predetermined location; and
determining the subset of the one or more objects that could have been at the predetermined location during the predetermined time period wherein for each detection location and detection time period associated with an object:
if the object could have been transported via zero or more object transportation means from a detection location at or after the start of the associated detection time, to arrive at the predetermined location at or before the end of the predetermined time period; or
if the object could have been transported via zero or more transportation means from the predetermined location at or after the start of the predetermined time period to arrive at a detection location at or before the end of the associated detection time;
   then the object is a member of the subset of objects that could have been at the predetermined location during the predetermined time period.

According to a ninth aspect of the present invention, there is provided a method for determining, in an object transportation network having one or more transportation means that at discernable times, transport zero or more objects along paths between nodes of the network, the subset of the zero or more objects detected entering, exiting or in the network that could have been at a predetermined location for the entire duration of a predetermined time period, the method including the steps of:
associating zero or more sets of times with each node in the network wherein each set of times includes a reference time and the latest possible time that an object could have departed each other node in the network and arrived at the node by the reference time; and
associating with each object detected in the network, one or more detection locations and associated detection time periods; and
associating one or more nodes with each detected and predetermined location; and
determining, the subset of the one or more objects that could have been at the predetermined location for the entire duration of a predetermined time period wherein for each detection location and detection time period associated with an object,
if the object could have been transported via zero or more object transportation means from the detection location at or after the start of the associated detection time, to arrive at the predetermined location at or before the start of the predetermined time period;
and if the object could have been transported via zero or more transportation means from the predetermined location at or after the end of the predetermined time period to arrive at a detection location at or before the end of the associated detection time
   then the object is a member of the subset of objects that could have been at the predetermined location for the entire duration of a predetermined time period.

According to a tenth aspect of the present invention, there is provided a method for determining, in an object transportation network having one or more transportation means that at discernable times, transport zero or more objects along paths between nodes of the network, the feasibility of an object being able to transit from one predetermined location at an associated time to a second predetermined location at a second associated time via zero or more other predetermined locations that also have an associated time, the method including the steps of:
a) associating zero or more sets of times with each node in the network wherein each set of times includes a reference time and the latest possible time that an object could have departed each other node in the network and arrived at the node by the reference time; and
b) representing each predetermined location and its associated time as one or more predetermined locations and associated times that are each associated with a single node; and
c) arranging the set of predetermined locations and associated times into chronological order of associated times; and
d) for each adjacent pair of predetermined locations in the chronologically ordered set, starting with the most recent and second most recent predetermined locations: using the zero or more sets of times associated with each node in the network to determine if an object could have been transported via zero or more object transportation means from the least recent predetermined location in the pair at or after the start of the least recent associated predetermined time, to arrive at the more recent predetermined location in the pair at or before the end of the more recent associated predetermined time; and
e) if traversal between all pairs of predetermine locations considered in step d) 0 were possible within the respective predetermined times, the set of predetermined locations at the associated predetermined times is determined to be feasible;
   wherein, any predetermined time may be expressed as either a discrete time or time period

According to a eleventh aspect of the present invention, there is provided a method for determining, in an object transportation network having one or more transportation means that at discernable times, transport zero or more objects along paths between nodes of the network, the feasibility of an object being able to transit from one predetermined location at an associated time to a second predetermined location at a second associated time via zero or more other predetermined locations that may or may not have an associated time, the method including the steps of:
a) associating zero or more sets of times with each node in the network wherein each set of times includes a reference time and the latest possible time that an object could have departed each other node in the network and arrived at the node by the reference time; and
b) representing each predetermined location and any associated time as one or more predetermined locations and associated times that are each associated with a single node; and
c) arranging the set of predetermined locations and associated times into a predetermined order of object traversal between predetermined locations such that each adjacent pair of predetermined locations represents an origin and destination of a segment of a larger journey; and
d) assigning a predetermined time to the last predetermined location if no such time was associated with the last predetermined location; and
e) for each adjacent pair of predetermined locations in the ordered set, associating the first location as a departure location and the second location as an arrival location, starting with the last and second to last predetermined locations:
   i) using the zero or more sets of times associated with each node in the network to determine the latest possible time that an object could have departed the origin location and arrived at the destination location by the end of the destination's associated time; and
   ii) if the departure location has no associated time, assigning the latest possible departure time as the departure location's associated time; and
   iii) if the departure location already has an associated time, checking that the latest possible time obtain in the step of associating zero or more sets of times with each node in the network 0 is no later than the departure location's associated time; and
f) if no further adjacent pairs of predetermined locations exist, then traversal of the set of predetermined locations at the associated predetermined times is determined to be feasible;
   wherein, any predetermined time may be expressed as either a discrete time or a time period.

According to further aspects of the present invention, there is provided a system for implementing the above methods.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications in its scope.

### BRIEF DESCRIPTION OF THE DRAWINGS

A preferred embodiment of the present invention will be discussed with reference to the accompanying drawings wherein:

FIG. 1 depicts an example network illustrating various elements of the network;

FIG. 2A provides example departure opportunities for node 1 as of 0900 hours operating within the network depicted in FIG. 1;

FIG. 2B provides example departure opportunities for node 2 as of 0900 hours operating within the network depicted in FIG. 1;

FIG. 3 provides example arrival and departure times for transportation means 1 operating within the network depicted in FIG. 1;

FIG. 4 provides example arrival and departure times for transportation means 2 operating within the network depicted in FIG. 1

FIG. 5 provides example arrival and departure times for transportation means 3 operating within the network depicted in FIG. 1

FIG. 6 provides example arrival and departure times for transportation means 4 operating within the network depicted in FIG. 1

FIG. 7 provides example objects 1-N (node and time of entry time) and (node and time of exit time);

FIG. 8 provides a timeline indicating times that an object enters the network, exits the network, and transportation means arrivals and departures at entry and exit nodes with respect to an incident time and at incident node.

FIG. 9 depicts sample objects for departure discovery and object traversal of the network;

FIG. 10 depicts the flowchart of processing steps required to perform the recordal of the transportation means arrival events processing;

FIG. 11 depicts a flowchart of processing steps required to perform the recordal of the merger of departure opportunities as part of transportation means arrival processing;

FIG. 12 depicts a flowchart of processing steps required to perform the recordal of the transportation means departure events processing;

FIG. 13a depicts a flowchart of processing steps required to perform the object entry event processing;

FIG. 13b depicts a flowchart of processing steps required to perform the object exit event processing;

FIG. 14 depicts a flowchart for a transportation means incident query regarding an object's likely whereabouts having as its output a set of candidate journeys (and therefore objects);

FIG. 15 depicts a flowchart for a soft-time incident query regarding an object's likely whereabouts having as its output a set of candidate journeys (and therefore objects); and

FIG. 16 depicts a flowchart for a rigid-time incident query regarding an object's likely whereabouts having as its output a set of candidate journeys (and therefore objects); and

FIG. 17 depicts a flowchart of a feasibility query for ordered node-time records; and

FIG. 18 depicts a system for performing the methods described herein.

In the following description, like reference characters designate like or corresponding parts throughout the several of the drawings.

### DETAILED DESCRIPTION OF EMBODIMENTS OF THE INVENTION

For the embodiment provided, it is useful to have a definition for some of the often used terms. The definitions provided are provided to assist the reader to better understand the embodiment but are not intended to limit the invention that is disclosed and defined herein.

System. The combination of a network and one or more transportation means for transporting zero, one or more objects about the system. This also includes computer systems for detecting object and transportation means as well as running the method described herein.

Network. A collection of nodes that are connected to each other either directly or via other nodes by paths such that transportation means can transport objects between any two adjacent nodes on the network via a respective path or paths.

Node. A location in the network at which transportation means arrive and depart and where objects can enter or exit the network.

Path. A portion of the network that is traversed by a transportation means travelling between two adjacent nodes. Path traversal may be one or two way at a time.

Route. An ordered sequence of nodes that defines the journey that a transportation means or object takes to travel from one node to another within the network which may repeat.

Transportation Means (also referred to as transport means in some figures). An abstract representation of a container (such as a physical train, courier van, airline luggage cage, electronic encapsulation/packet, etc.) that can transport objects (such as people, packages, letters) or information (such as data in for example digital form) between nodes at discernible times.

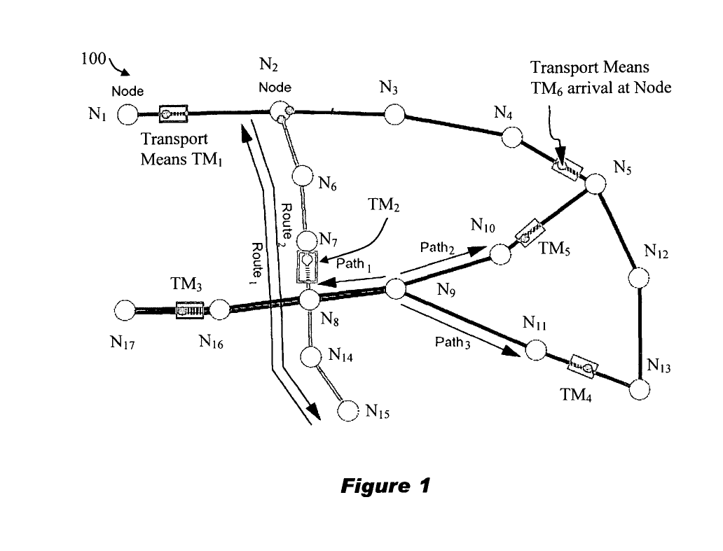

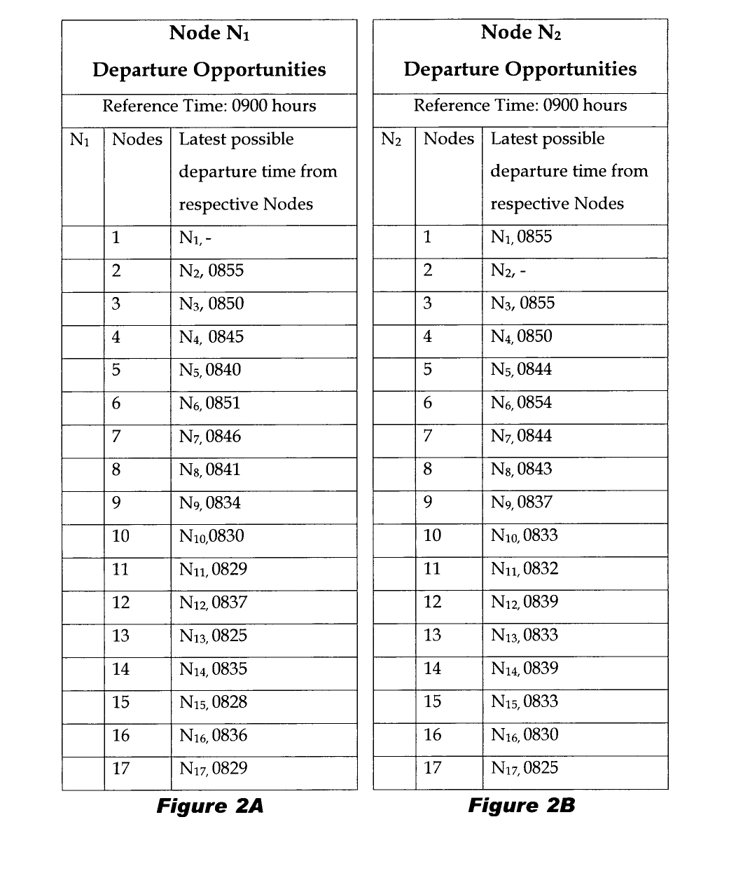

FIG. 1 depicts an example network (100) illustrating the use of some the above terms. Transportation means TM₁, TM₂, TM₃, TM₄, TM₅, TM₆.move along paths between Nodes N₁ to N₁₇ of the network. Exemplary paths and routes are illustrated. Arrival and departure times are also recorded. For example TM₁ could have departed Node N₁ at 0730, and travelled to N₁₃ via N₂, N₃, N₄, N₅, and N₁₂, and then returning along the same route back arriving back at N₁ at 0900. TM₂ could have departed N₁₅ at 0828 and followed Route₁ and then onto node N₁ arriving at 0859 (ie just prior to TM₁). TM₃ could have departed N₁₇ at 0829 and followed part of Route₁ and onto node N₁ arriving at 0858 (ie just prior to TM₂). departed N₁₇ at 0829 and followed part of Route₁ and onto node N₁ arriving at 0858 (ie just prior to TM₂). TM₄ could have departed N₁₃ at 0825 and travelled to N₁₇ via N₁₁, N₉, N₈, and N₁₆, running as an express from N₈ to N₁₇ arriving at 859. Example arrival and departures are presented in FIGS. 2A, 2B, 3, 4, 5 and 6.

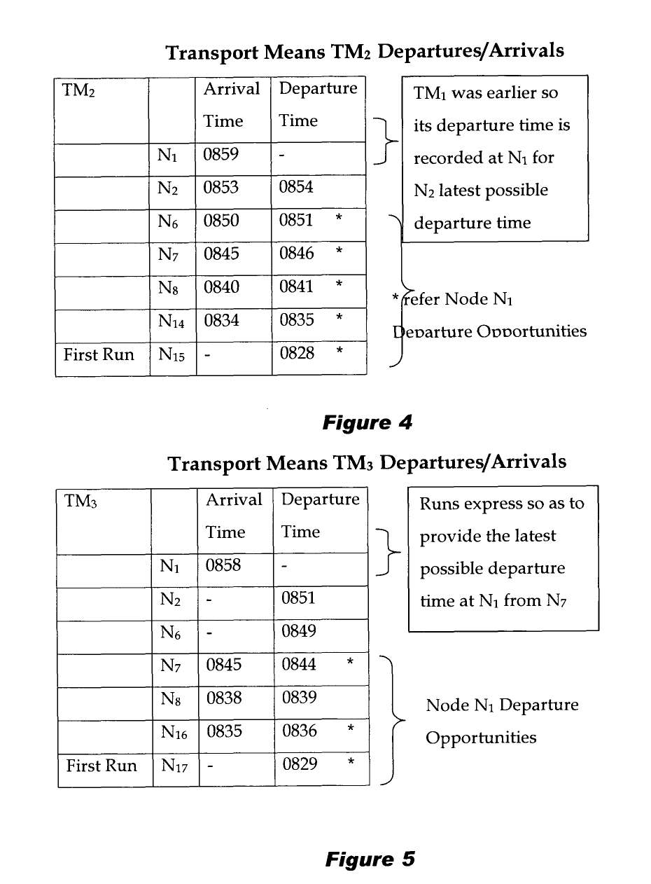

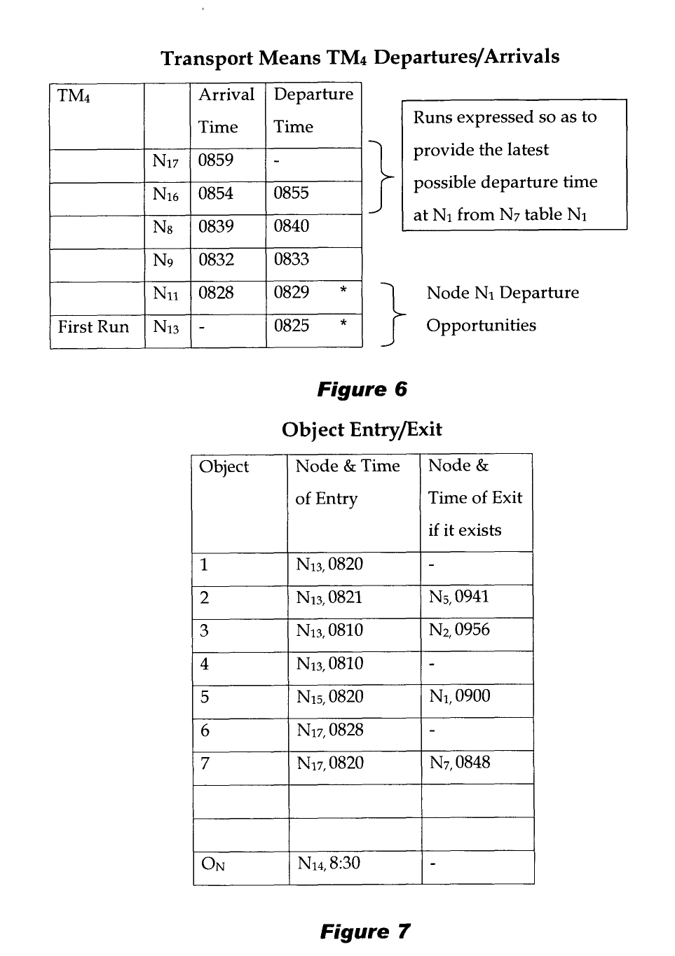

Objects may also be detected entering, exiting and in the network. Preferably detection is performed on entry and exit, but in some cases entries or exits may not be detected or may not have occurred (ie the object is still in the network. FIG. 7 provides an example of record of object entries and exits into the system presented in FIG. 1. FIG. 7 presents the various entry times of objects 1 to 4 at Node N₁₃. With reference to FIG. 6, objects 1-4 could have been transported by transportation means TM₄ which departed N₁₃ at 0825. Object 3 could have been transported to Node N₈ arriving at 0839. At 0840 TM₂ arrived at Node N₈ and thus object 3 could have then been transported to Node N₂, arriving at 0853 where it could have waited before departing at 0956 (see also FIGS. 4 and 6). Other possible routes are also possible. For example object 7 entered the network at Node N₁₇ at 0820 and could have departed at 0828 on TM₃ (FIG. 5) to Node N₇ at 0844 and then exited at 848

Recordal of the time of the following events can be maintained at any location, preferably external to the physical location of the network:
the arrival time of a transportation means at a node
the departure time of a transportation means from a node
the entry time of an object into the network at a node
the exit time of an object from the network at a node

These events can be generated by one or more means including but not limited to devices on each transportation means and sensors to detect the devices at the physical entry and exit point of nodes relative to the transportation means being detected. By way of example, a device such as a Radio Frequency Identity Device (RFID) or vehicle registration number attached to a parcel truck is used to identify that a particular truck has entered or exited a parcel despatch depot. Similarly by way of example, a sensor that detects a train arriving at and departing from a platform at a station.

By way of example an object such as a parcel may be augmented with a Bar Code or RFID tag and then sensed by a sensor at a point at which a parcel can enter and/or exit the network. Similarly by way of example, an object could be a person entering and/or exiting a network using a ticket at a turnstile where the turnstile acts as a sensor, or where the entry and/or exit of the person is determined via image or biometric means. Due to limitations to the workings of such sensors and identification devices, it is possible that not every object will be reliably detected as it enters or exits the network. It is by preference that both entry and exit of each object is detected and recorded. However, it is only preferable but not necessary that each object is detected in the network, for example at a node or on a transportation means. In cases where no entry or exit is detected then there exist many possible entries and exits. In most cases this will extend to all nodes in the network, and correspond to either a network start or end time, or at least the time that network services started or ended at the node. Thus if only a detection event is recorded it is preferable that it is an entry or exit as this reduces the possible search space for determining if an object could have been a location of interest at a specific time.

The sensor is preferably connected to a data network, such as a computer network by any suitable means, wired or wirelessly, and the data collected representative of an event is sent to a computer to be associated with a record of the event. The data collected may provide real time information or be stored for future use. The computer may for example be a database server that is accessible via the world wide computer network referred to as the Internet which would make such data available securely or otherwise to others as required.

In one example of a system for receiving and manipulating the information generated by the network elements such as sensors associated with transportation means and nodes, a first computer processor and associated memory are arranged in a known manner to receive and record information from the network elements and associate that information with respective records associated with object, transportation means and nodes. One or more computer processors and associated memory can be used to receive the recorded information and analyse that information to satisfy queries that provide candidate journeys or objects for further review according to one or more incident scenarios. It may be that the various computer processors are in fact only one processor and associated memory or they may be spatially separated.

A time source shared by all the sensor locations is preferably achieved by known means, for example via the Internet using a globally accessible time standard so that the timing of events is recorded with respect to a common time source. Alternatively, an automatic, semi-automatic or manual means for determining the time difference between sensors relative to a common time reference is required in order to derive consistent event timing across all sensors.

In the case of a person (object) entering, for example only, a train station, the use of an access device to gain entry or exit from the network such as a magnetic stripe card, smart card or swipe type ticket can be used to trigger the recordal of the event of an object entering or exiting the network. In some cases, access may be made available via image or biometric means, or some combination of ticket, card, image and/or biometric means. In some cases the card, ticket or other access means is associated with a particular person or object or is traceable to that person or object, while sometimes mere possession of such a card, ticket or other access means is sufficient to make use of the network. In the case of a person using an access means who is not in some way uniquely associated with their particular allocated access means, there may also be a photographic/video record associated with that event. In other embodiments, the access means can be assumed to be associated with a particular person and in some embodiments, biometric confirmation can increase the likelihood that the person is the user of the access means. The exit of a person from a train network can be logged in a similar manner, although the working of the algorithms described herein are not reliant on the recordal of both the entry and exit event. Furthermore the detection of an object (such as person) located at a node or on a transportation means is also possible.

The detection period may be a single point in time (such as the time a ticket is used at a turnstile), or for an extended period of time (such as when video surveillance is used).

As illustrated in FIG. 1 the various transportation means may transport objects around the network. Travel between nodes takes a finite amount of time and the ability of an object to be moved around the network will also depend upon the various times that the various transportation means arrive and depart the nodes of the network. In some circumstances, such as an incident occurring at some location in the network (such as at a node or on a transportation means) we may be interested in knowing the time period or periods at locations other than the location of interest during which it was feasible for an object to have either been transported to or from the location of interest during the time period (which may be a time point) of interest. We may further be interested in determining the subset of objects which could have been at the location of interest during the time period (or point) of interest.

In some cases we may not be interested in tracking specific objects but may just interested be in determining the time periods during which it was possible to move around the network subject to certain criteria. For example a location and time period of interest could be specified, and then relevant time periods in which it was possible to have been at this predetermined location and predetermined time period. Complex queries involving multiple locations and time period (or point) of interest can be developed by performing a set of single queries (for each location and time period or point of interest). The outputs could then be combined to determine, for example, the set of possible times at each of the nodes that would have allowed movement to or from the times and locations specified in the complex query. For example if one had a series of detections or events that occurred at multiple points in the network (eg a leaking container which was transported around the network), then you may wish to determine what other locations and times could have been affected, such as an object being contaminated and spreading the contaminant elsewhere.

Solving such queries requires taking into account the finite time it takes to move around the network on the transportation means (aside from the case where the specified location is the predetermined location of interest in which case no movement is necessary) as well as the arrival and departure times of the transportation means at the various nodes. Typically when such a query is performed a location and time period (or point) of interest is specified and thus this is predetermined at the time the query is performed. Time periods of interest may in fact be instances in time, in which case the start and end times are identical.

In one aspect of the invention we determine time periods for each node of the network. The time periods define when it was possible for an object to transport from the node to a location of interest at a time point of interest, or when it was possible for an object to be transported from the location of interest at a time point of interest to the node.

In another aspect of the invention we determine time periods for each transportation means of the network. The time periods define when it was possible for an object on the transportation means to be transport from the transportation means to a location of interest at a time point of interest, or when it was possible for an object to be transported from the location of interest at a time point of interest to the transportation means.

In another aspect we associated a set of times with a node, wherein the set of times includes a reference time and the latest possible time that an object could have departed each other node in the network and arrived at the node by the reference time. This is done for all nodes at various times and together with object entry or exit information permits determination of the subset of the one or more objects that could have been at a predetermined location during a predetermined time period.

In another aspect we associate a set of times with a node, wherein the set of times includes a reference time and the latest possible time that an object could have departed each other node in the network and arrived at the node by the reference time. This is done for all nodes at various times, and together with object entry or exit information permits determination of the subset of the one or more objects that could have been at a predetermined location during the entire duration of a predetermined time period.

In another we again associate a set of times with a node, wherein the set of times includes a reference time and the latest possible time that an object could have departed each other node in the network and arrived at the node by the reference time. We also define a journey history for each object which includes the entry and exit nodes and respective times. By looking up a specific set of times associated with the predetermined location, and the set of times associated with the exit node we a determination may be made of whether the object in the subset of the one or more objects that could have been at a predetermined location during a predetermined time period.

In another aspect we associate a set of times with a node, wherein the set of times includes a reference time and the earliest possible time that an object could have arrived at each other node in the network having departed the associated node by the reference time. This is performed for all nodes at various times and together with object entry or exit information permits determination of the subset of the one or more objects that could have been at a predetermined location during a predetermined time period.

In another aspect the effect of extended object arrival and detection time periods is described. In a further aspect each detection location and associated detection time period (and node-time record), and the predetermined location and predetermined time period, are arranged into chronological order and pairs of node-time records are processed to determine the subset of the one or more objects that could have been at a predetermined location during a predetermined time period.

In a further aspect each detection location and associated detection time period (and node-time record), and the predetermined location and predetermined time period, are arranged into chronological order and pairs of node-time records are processed to determine the subset of the one or more objects that could have been at a predetermined location during the entire duration of the predetermined time period.

In another aspect, the feasibility of an object being able to transit from one predetermined location at an associated time to a second predetermined location at a second associated time via zero or more other predetermined locations that also have an associated time is described. This method again associates a set of times with a node, wherein the set of times includes a reference time and the latest possible time that an object could have departed each other node in the network and arrived at the node by the reference time.

In another aspect, the feasibility of an object being able to transit from one predetermined location at an associated time to a second predetermined location at a second associated time via zero or more other predetermined locations that may or may not have an associated time. This method again associates a set of times with a node, wherein the set of times includes a reference time and the latest possible time that an object could have departed each other node in the network and arrived at the node by the reference time.

Thus in one aspect, the invention includes determining for each node of the network, the time period during which an object could have been transported to the predetermined location from the node, wherein the transportation occurred prior to or during the predetermined time period. This accounts for objects being transported to the predetermined location of interest and waiting there until the start of the time period of interest. This embodiment further includes determining, for each node of the network, the time period during which an object could have been transported from the predetermined location to the node, wherein the transportation occurred during or after the predetermined time period. This accounts for the object having been at the predetermined location of interest and waiting until some time after the end of the incident before moving to the node the time point is defined for.

The effect of finite travel times, and that transportation means arrive at and depart a node at specific times (rather than any time) is that if we consider a node in the network (that is not the node of interest) the relevant time period for transport to the predetermined node is bounded by the latest time that an object could have left the current node and arrived the predetermined location prior to or at the predetermined time point. After that time it is no longer physically possible to move from this node to the node of interest before the time point of interest. Similarly the relevant time period for transport from the predetermined node to another node is bounded by the earliest time that an object could have departed the predetermined location and arrived at the node, wherein the departure was on or after the predetermined time point of interest.

Turning now to FIG. 8, we consider an object entering the network at entry node Nₑ at time tₑ. In this case the predetermined location of interest is labelled the incident node Nᵢ, and time period of interest is (t₁, t₂). In this case we consider an object that enters the network at node Nₑ at time tₑ, and leaves the network at node Nₓ and time tₓ. In the current situation we are interested in determining if the object could have been at the predetermined location during the predetermined time period.

The times that three transportation means depart this entry node is indicated at t_{e,d1}, t_{e,d2}, and t_{e,d3}. Firstly we note that the object could not have physically departed at t_{e,d1}. However the object could have waited at the node and then departed at either t_{e,d2}, or t_{e,d3}. If the object departed at t_{e,d2} then it could have physically travelled to the incident node Nᵢ during the time period of interest (t₁, t₂). However if it departed at t_{e,d3} then it could not have physically travelled to the incident node Nᵢ during the time period of interest (t₁, t₂).Thus for the entry node, there is a time period starting from the network start time (in this case 0) and ending at t_{e,d2} (ie time period (0, t_{e,d2})) during which it was possible to have been at node Nₑ and have travelled to the incident node during the time period of interest.

The times that three transportation means arrived at the exit node is indicated at t_{x,a1}, t_{x,a2}, and t_{x,a3}. Firstly we note that the object could not have physically arrived at t_{x,a3}. However the object could have arrived at either t_{x,a1}, or t_{x,a2} and waited at the node before exiting at tₓ. In the current case, the object could have physically travelled from the incident node Nᵢ during the time period of interest (t₁, t₂) and arrived at the exit node at t_{x,a1}. However it was possible for the object to have been at the incident node Nᵢ during the time period of interest (t₁, t₂) and then travelled to the exit node at t_{x,a2}. Thus for the exit node, there is a time period starting from t_{x,a2} and ending at the network end time (in this case t_{end}) (ie time period (t_{x,a2}, t_{end}), during which it was possible to have been at the incident node Nᵢ and have travelled to the exit node during or after the time period of interest.

Thus in the above case, the object would be in the subset of all objects that could have been at the predetermined location during the predetermined time period, as the object was detected at a node during a time period that a transportation means departed from and arrived at the incident node prior to or during the predetermined time period. If the object was detected on a transportation means, then the nodes that the transportation means visits could be examined and if a departure or arrival time is within a time period for the node the transportation means is visiting it can be determined that the object could be at the predetermined location during the predetermined time period (whether it is transported by the current transportation means, or by one or more other transportation means). In the case that the predetermined location of interest is a transportation means, the nodes that the transportation means visits (along with the departure and arrival times) could be used as proxy locations for the transport means.

Additionally or alternatively, it is possible to define similar time periods for each transportation means. For example one could determine for each transportation means in the network, the time period during which an object on the transportation means could have been transported to the predetermined location by one or more transportation means, wherein the transportation occurred prior to or during the predetermined time period. Additionally one could determine, for each transportation means in the network, the time period during which an object could have been transported from the predetermined location to the transportation means by one or more transportation means, wherein the transportation occurred during or after the predetermined time period. Thus if an object was detected at a node that a transportation means arrived at, or departed from, during a time period defined above for the transportation means, or if an objected was detected on a transportation means during a time period defined above for the transportation means, then the object is a member of the subset of objects that could have been at the predetermined location during the predetermined time period.

To further assist in understanding the invention, an embodiment of the invention, which for ease of referral is termed the Traversal Discovery method will now be described in detail. The Traversal Discovery method includes recording transportation means arrivals to and departures from nodes on a network so that at a minimum, a time-ordered matrix of departure times (or equivalent data structures), which are termed Departure Opportunities, can be gathered to support queries such as:
What is the latest possible time that an object could be present at each node on the network and use the network's fastest combination of transportation means to reach a nominated node by a specified time?
What is the ability for an object to reach each node on the network by a particular time if the entity left a nominated node at a specified time and used the network's fastest combination of transportation means?

The method used to satisfy these and other queries preferably process actual arrival and departure times as opposed to scheduled times so that a realistic feasibility of an object being present at a particular network location or on a particular path at a particular time can be established. However it is to be understood that the method could be used on scheduled times to make predictions of possible movements of objects within the network.

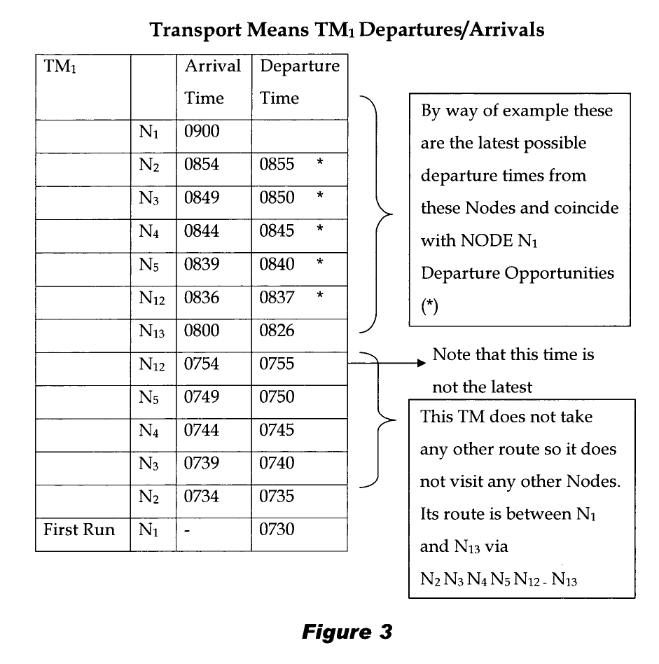

Over time from a start time, by way of example and in an embodiment,
each node will preferably have associated with it a matrix of latest possible departure times from every other node, generated for a every transportation means' arrival at the node;
   An example of this type of matrix is provided in FIGS. 2A and 2B that show respectively for node 1 and node 2 the Latest Possible Departure Time from each other node in the network. This table in FIG. 2A is a slice of the matrix of the situation as of 0900 hours. New slices will be added to the matrix as new transportation means arrive at the node. Refer to FIG. 1 to determine the nodes indicated in the table.
for each transportation means, a chronologically ordered sequence of visited nodes with each visit's arrival and departure times, and the transportation mean's known route up to that time may be stored (or associated);
   An example of this type matrix is provided in FIGS. 3, 4, 5 and 6 that show respectively for transportation means TM₁, TM₂ TM₃ and TM₄ (ref to FIG. 1). There are of course many other transportation means used in the network, but they are not shown in this limited example. As described in the FIGS. 3, 4, 5 and 6, different transportation means provide the Latest Possible Departure Time from respective nodes as they arrive at each node. Each transportation means matrix shows the route up to the current time of 0900 hours.
   In FIG. 2A the route N₁, N₂, N₃, N₄, N₅, N₁₂ and N₁₃ provides the Latest Possible Departure Time from respective nodes as recorded in Table 2A for node 1.
   In FIGS. 4, 5 and 6 the * indication is adjacent to various Departure Times that provide the Latest Possible Departure times as recorded in respect of node 1.
a set of entry and exit times and the respective node of entry and exit for each journey taken by an object that enters the network.
   FIG. 7 provides for 1 to N objects the node and time of entry and node and time of exit. Not always are both the entry and exit time and node available.

In the above example a matrix was associated with each node containing the latest possible departure times from every other node which is generated every time a transportation means' arrives at the node. However other data structures may be used and sets of times may be stored more frequently. More generally a set of latest possible departure times may be associated with a node or a transport means. In a broad aspect we record the fastest time that it is possible to have been transported from one location, to another location in the network by a particular reference time. Due to the nature of the network, the number of effective locations that we need to consider are the nodes, transportation means, and paths in the network.

Such information on the latest possible departure times to arrive at a nodes and/or a transportation means in the network, whether in the form of a series of records, data base tables, matricies, etc, may be built up, or obtained for an operational period of interest. The operation period of interest is effectively a time period of interest during which the network is in operation (that is objects may be transported) and may be a shorter time period than the actual period the network operates for. It is possible to represent the network in software, and provided information on time of arrivals and departures of transportation means during the operation period of interest is provided, it is possible to determine time periods when movement between one location or another is feasible. If one further has information on object movements such as entry node and time, and/or exit node and time, and/or a detection location in the network (and associated detection time) then it is possible to determine which objects could have been at locations of interest during time periods of interest. In the follow discussion we will label queries which seek to determine if an object could have been at a predetermined location at any point in a predetermined time period as a soft-time query, and we will label queries which seek to determine if an object could have been at a predetermined location for the entire duration of a predetermined time period as a rigid-time query.

In one embodiment described in more detail a method of determining such queries includes associating a set of times which each node and each transportation means. We represent movement of transportation means around the network and the nodes and transportation means exchange and/or merge sets of times to enable information on the fastest way to move around the network to be generated. Such information can be used in the queries discussed above.

An embodiment of the Traversal Discovery method for determining the subset of the one or more objects that could have been at a predetermined location during a predetermined time period will now be discussed. In this approach a set of times is associated with a node, wherein the set of times includes a reference time and the latest possible time that an object could have departed each other node in the network and arrived at the node by the reference time. Such a set of times will be referred to as a Departure Opportunities. Zero, one or more sets of times may be associated with each node of the network. The zero case occurs for example when the node is either not operational, or in the case of infrequent services, the node is not visited. In larger networks with many frequently moving transportation means it is to be expected that each node will have many sets of times associated with the node (each having a different reference time). In such cases a flag could be set to note that the node is not in operation or that no visits occurred. Various data structures such as lists, vectors, arrays/matrices, database tables, pointers, etc may be used to store such information and associate it with a node.

In this embodiment, one or more nodes are associated with the predetermined location and at least one detection location and detection time period is associated with each object detected entering, exiting or in the network. These pieces of information may be combined to determine subset of objects that could have been at the predetermined location during the predetermined time period. For example if at least one associated detection location and time period for an object and at least one of the zero, one or more sets of times associated with each node in the network permit (ie allow) the object to be transported to or from the one or more nodes associated with the predetermined location, the transportation to occurring prior to or during the predetermined time period, and the transportation from occurring during or after the predetermined time period then the object is a member of the subset of objects that could have been at the predetermined location during the predetermined time period.

Determining if at least one associated detection location and time period for an object and at least one of the zero, one or more sets of times associated with each node in the network permit (ie allow) the object to be transported to or from the one or more nodes associated with the predetermined location, may involves performing multiple tests and such a query can be constructed in a variety of ways. For example one could loop over all detection locations and timer period, and then loop over all sets of times associated with each node, and perform a test for each combination. Alternatively one could choose specific sets of times (such as those associated with specific nodes) to compare rather than all sets. Database tables or other data structures could be used to make such comparisons more efficient.

Preferably a set of times is associated with a node each time a transportation means arrives at the node, in which case the reference time is the time of arrival of a transportation means at the node.

The method maybe further enabled by associating a set of times with each transportation means, wherein each set of times associated with a transportation means includes a reference time and the latest known time that an object could have departed each node in the network prior to the reference time. The set of times associated with a transportation means may be updated each time a transportation means departs a node, wherein the reference time is the time of departure, and the set of times is updated based upon the set of times associated with the departure node having a reference time closest in time before or equal to the time of departure. Further, when a transportation means arrives at a node the set of times associated with the node is obtained from merging the set of times associated with the transportation means and the set of times associated with the node having a reference time closest in time prior to the arrival of the transportation means, wherein merging is performed such that the time associated with each other node is the most recent time from the two sets of times. The above process of merging and exchanging times between transportation means and nodes provides one way in which information on the fastest possible routes within the network may be provided to nodes.

Associating at least one detection location and detection time with each object detected entering, exiting or in the network may also include associating at least one journey history record with each detected object. Each journey history record includes at least one possible entry node and associated entry time for the object; and at least one possible exit node and associated exit time for the object. Preferably the object is detected entering and exiting the location in which case these detection locations and time periods are associated with the journey history. However in some cases data may be missing or incomplete data in regard to objects entry in or exit from the network. If say an object was spotted entering, but not exiting the network, then all nodes of the network are possible exit nodes. In this case the exit time could be a predetermined network end time, or alternatively each node could have an associated exit time corresponding to the time that network services ended at that node. Similar reasoning applies to the entry nodes.

Associating a node with the predetermined location may be performed by determining if the predetermined location corresponds to a node; a transportation means, or a path between two nodes. If the predetermined location corresponds to a node, then the associated one or more nodes is the corresponding node, or if the predetermined location corresponds to a transportation means, then the associated one or more nodes includes the node the transportation means departed immediately prior to the start of the predetermined time period, or if the predetermined location corresponds to a location on a path between adjacent nodes, the one or more nodes includes at least one of the nodes associated with the path.

Determining if an object is in the subset of the one or more objects that could have been at a predetermined location during a predetermined time period can be performed by using the above information. An object is a determined to be a member of the subset of objects that could have been at the predetermined location during the predetermined time period if for any of the one or more nodes associated with the predetermined location, any of the at least one possible entry time associated with a possible entry node for the object is equal to or prior to the time corresponding to the associated entry node the set of times having a reference time closest in time prior or equal to the end of the predetermined time for the current node associated with the predetermined location, or, for any combination of possible exit node of the object and the current node associated with the predetermined location, the start of the predetermined time period is equal to or after the time corresponding to the time associated with any of the one or more nodes associated with the predetermined location in the set of times associated with the possible exit node having a reference time closest in time prior or equal to associated exit time.

Alternatively, rather than using the entry node and exit time in the journey history record, the detection events just prior to the start of the incident, or just after the end of the incident could be used. For example a prior node and associated prior time could be associated with the object based upon the node and time associated with the more recent detection of the object prior to the start of the predetermined time period. Similarly a post node and associated post time could be associated with the object, based upon the node and time associated with the more recent detection of the object after the end of the predetermined time period. These could then be used in determining if an object is a member of the subset of objects that could have been at the predetermined location during the entire duration of the predetermined time period by considering. One could consider each of the one or more nodes associated with the predetermined location.

Then if the prior time (associated with the prior node which is associated with the object) is equal to or prior to the time corresponding to the associated prior node in the set of times having a reference time closest in time prior or equal to the start of the predetermined time for the current node associated with the predetermined location, or if, for the post node associated with the object and the current node associated with the predetermined location, the end of the predetermined time period is equal to or after the time corresponding to the time associated with current node associated with the predetermined location in the set of times associated with the post node having a reference time closest in time prior or equal to the associated post time, then the object is in the subset.

This approach can of course be similarly adapted to a rigid time query where one is interested if the object was present for the entire duration by requiring both conditions to be true (rather than one or the other), and changing the end/start of the predetermined time period with start/end of the predetermined time period in the first/second parts of the if statement.

The following text can be used to assist the creation of a computer program to perform the functions described above. The terms used in the text below have been created to describe certain events and functions and alternative terms may apply in any future invocation of the functions as those terms are not intended to be unique identifiers of the event or function, merely a guide to the understanding of the workings of but one embodiment of the invention. Reference to the above mentioned tables will also assist an understanding of the text below but the tables are very limited examples only as real world environments include many tens, hundreds or thousands of nodes and transportation means, and potentially millions of objects.

A separate record (“NodeVisit”) is used to record every transportation means' visit to every node on the network. As a minimum, the nodeVisit record consists of a reference to the node being visited and the arrival and departure times of the visit. When a transportation means arrives at a node on the network, a nodeVisit record is constructed and populated to contain the node reference and arrival time. The departure time in the nodeVisit record is updated when the transportation means leaves the node by way of example refer to Table TM₁.

Each transportation means maintains a list of nodeVisit records representing the nodes they have visited over the course of their time in the network.

Each node maintains multiple sets of “Departure Opportunities” that represent the latest possible time that a transportation means could have left every other node on the network and still reached that arrival node by the arrival time. One set of Departure Opportunities is recorded by the node for every transportation means' arrival time at the node thus providing multiple sets of information which are maintained for the duration of network operation.

Network operation for the purposes of data collection is preferably over a fixed period, say the hours of 5 am to the following 4 am, but it is also possible to run the system over an indefinite time period provided techniques are employed to archive historical data when it can be determined that such data does not relate to any object currently within the network. It is also possible for previously recorded/archived data to be maintained in a store to support historical analysis at some future time.

Each transportation means also maintains at least one Departure Opportunities record. Every time the transportation means arrives at a node, the set of Departure Opportunities that are associated with the transportation means is made available to the arrival node. A new Departure Opportunities record consisting of the latest departure times for each node is created by or on behalf of the arrival node, where those departure times are drawn from the arriving transportation means's Departure Opportunities record and the most recently recorded Departure Opportunities record for the node. The new Departure Opportunities record is then recorded as the latest set of Departure Opportunities for the arrival node.

Every time the transportation means departs a node, a duplicate of the departure node's most recent Departure Opportunities record is directly or indirectly associated with the transportation means. The departure time for the node of departure within the duplicated Departure Opportunities record is updated to contain the time of departure for the transportation means. The updated duplicate Departure Opportunities record is then ready to be associated with the transportation means' next arrival node.

Whenever an object enters the network, its location (Node) and time of entry are recorded along with a reference to the object itself. When an object exits the network, the object's entry record is updated to include the time and location (Node) of exit, or, if no entry record can be found, an equivalent record is created to record the object's time and location (Node) of exit along with a reference to the object itself.

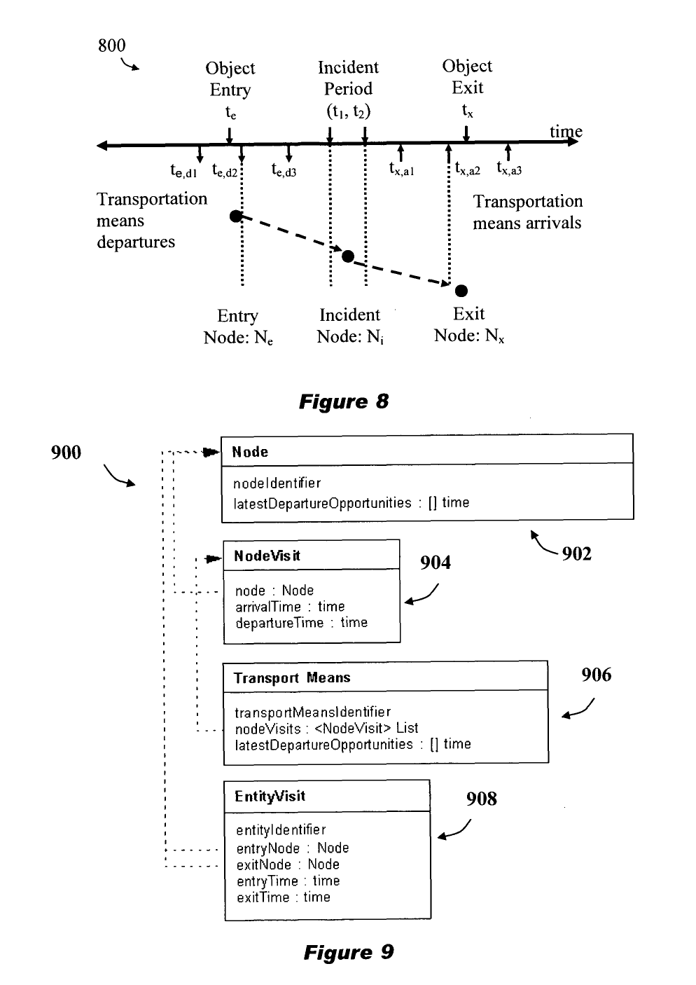

FIG. 9 depicts sample data structures (or objects) for Departure Discovery and object Traversal of the network as described in some detail above. These include a Node record (902), a NodeVisit record (904), and Transport Mean record (906) and and EntryVisit record (908). The dotted lines indicate relationships between the various objects.

The node record (902) includes a node identifier and the latest departure opportunities (a set of times indicating the latest possible time that an object could have departed each other node in the network and arrived at the node). A node visit record (904) includes a node record (902), and an arrival time and departure time. A transportation means record (906) includes a transportation means identifier, a list of node visits (node visit records (904), and the latest departure opportunities (a set of times). An entry visit (908) includes an entry identifier, an entry node, exit node, entry time, and exit time. The entry visit may also be considered to be one embodiment of a journey history for an object.

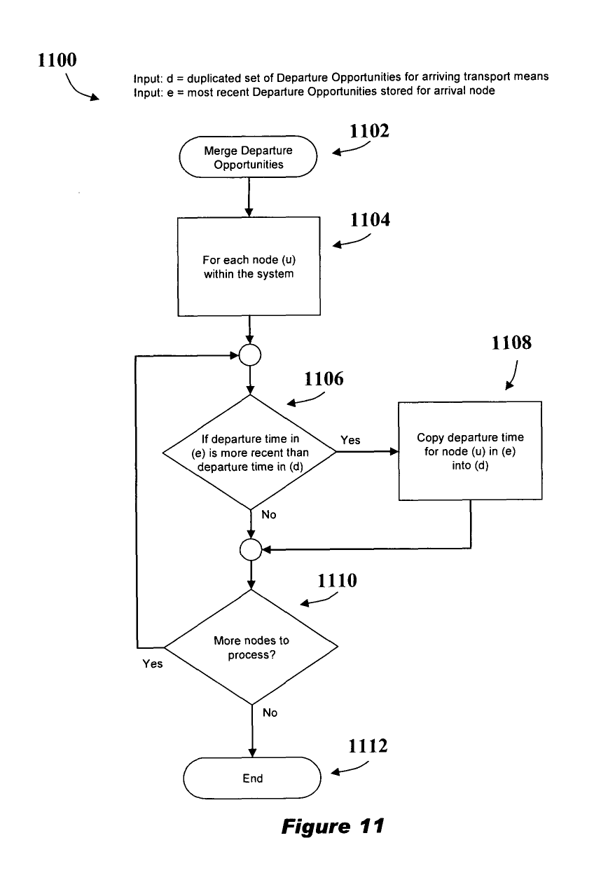

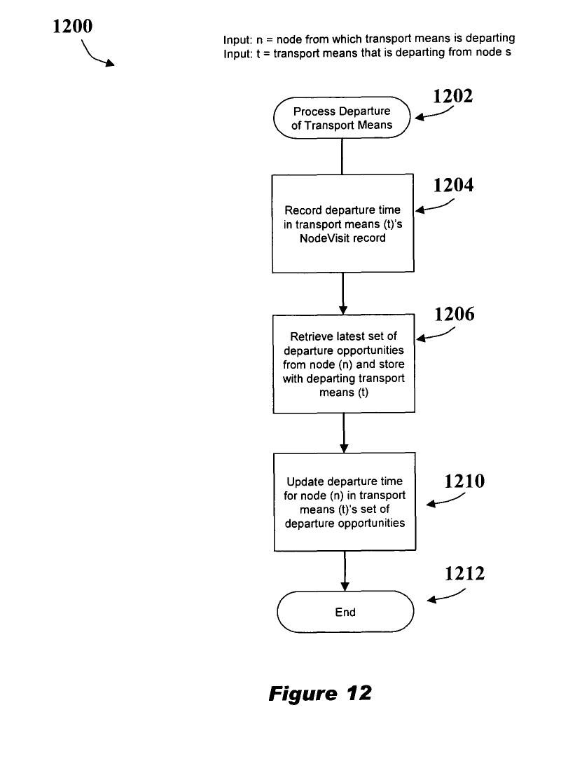

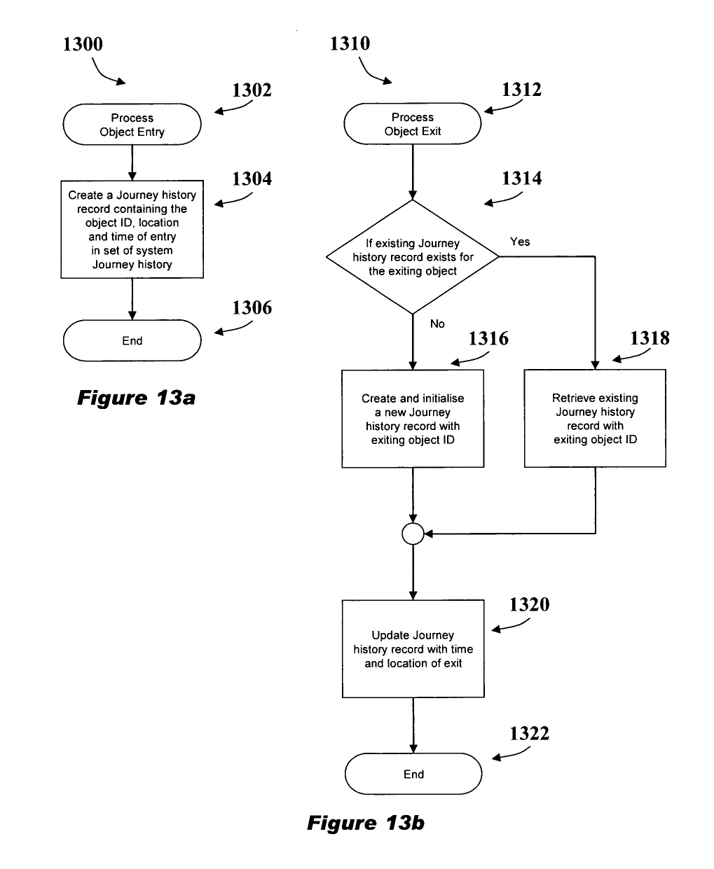

Tenets which describe the above approach and that are depicted in FIG. 9 are provided below.
The set of latest possible departure times (“Departure Opportunities”) from every node on the network are stored for every transportation means' arrival at every network node. [Node].
Departure Opportunities are transported (virtually if associations are used an data only is stored) by or on behalf of transportation means as transportation means traverse the network. [transportation means]. Refer to FIG. 12.
Departure Opportunities are updated by or on behalf of nodes by merging the latest possible departure times recoded by the arrival node with the set of departure times associated with the arriving transportation means. [Node Visit]. Refer to FIG. 11.
Object entry and exit times and locations (Nodes) are recorded for later analysis in conjunction with the stored Departure Opportunities. [Object Visit]. Refer to FIGS. 13a and 13b.

The following description outlines at least one embodiment of the method necessary to record and manipulate the previously described information so as to provide a response to a query.

Transport Means Arrival

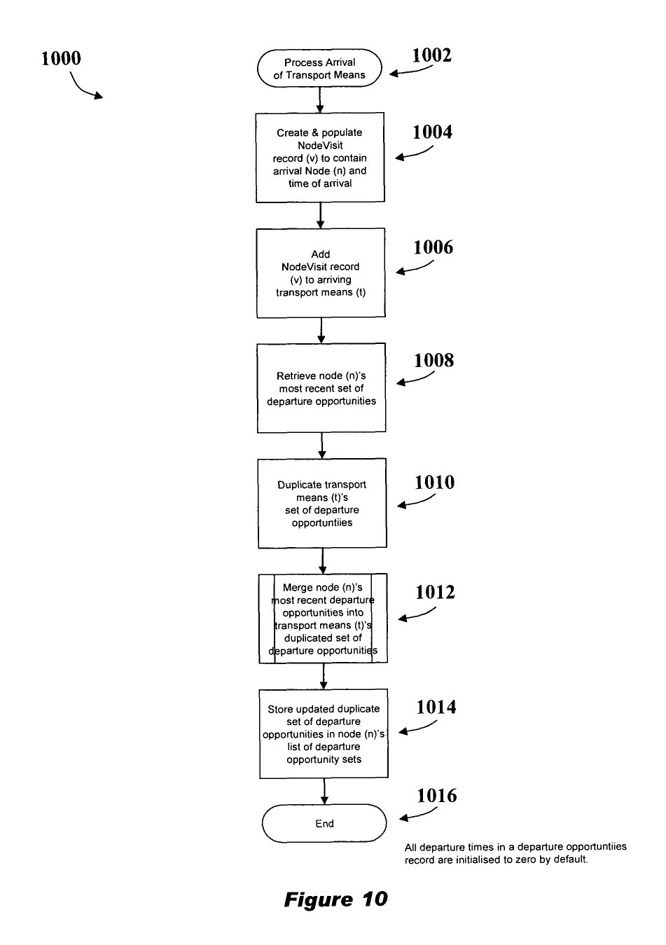

All departure times in a Departure Opportunities record are initialised to zero (or a value representing a time before the time of the first data) by default. FIG. 10 depicts the flowchart of processing steps required to perform the recordal of the transportation means Arrival Event 1000. We being processing the arrival of a transportation means at 1002. Firstly create & populate NodeVisit record (v) to contain arrival Node (n) and time of arrival (1004) and then at (1006) add NodeVisit record (v) to the arriving transportation means (t). Next retrieve node (n)'s most recent set of departure opportunities (1008), duplicate transportation means (t)'s set of departure opportunities (1010) and merge node (n)'s most recent departure opportunities into transportation means (t)'s duplicated set of departure opportunities (1012). Finally we store updated duplicate set of departure opportunities in node (n)'s list of departure opportunity sets (1014) and then ending (1016).

Flow-Charts for Establishing Information Suitable for a Later Discovery Process

FIG. 11 depicts a flowchart of processing steps required to perform the recordal of the Merger of Departure Opportunities (1100) as part of transportation means arrival processing described previously. At (1102) we begin the merge of departure opportunities. We have inputs d and e which correspond to the duplicated set of Departure Opportunities for arriving transportation means and the most recent Departure Opportunities stored for arrival node respectively. Then for each node (u) within the system (network) (1104) test if departure time in (e) is more recent than departure time in (d) (1106). If yes, copy departure time for node (u) in (e) into (d) (1108). Otherwise check if there are more nodes to process (1110). If yes return to step 1106, otherwise end (1112).

FIG. 12 depicts a flowchart of processing steps required to perform the recordal of the transportation means departure event processing (1200). Begin processing departure of transportation means (1202). We have inputs n and t, which correspond to the node from which transportation means is departing and the transportation means that is departing from node s respectively. Record departure time in transportation means (t)'s NodeVisit record (1204). Next retrieve the latest set of departure opportunities from node (n) and store with departing transportation means (t) (1206). Next update departure time for node (n) in transportation means (t)'s set of departure opportunities (1210) and then end (1212).

FIGS. 13a and 13b respectively depict flowcharts of the processing steps required to perform the object Entry (1300)/Exit (1310) events handling. A journey includes an entry event associated with an object, an exit event associated with an object or the entry and exit event associated with the same object. Such an approach allows for a variety of reasons that an object being transported by transportation means within a network can be considered as a candidate of interest with regards to one or more incidents that occur within the network.

Processing object entry (1302) begins with creation of a journey history record containing the object ID, location and time of entry in a set of system journey history (1304) and then ends (1306). Processing object exit (1312 includes testing if an existing journey history exists for the exiting object (1314). If yes, retrieve existing journey history record with exiting object ID (1318). If no, create and initialise a new journey record with the exiting object ID (1316). Finally update journey history record with time and location of exit (1320) and then end (1322).

Variants of these processes are possible. For example processing object entry could begin by asking if existing journey history exists for the entering object (o). If yes, then retrieve most recent journey history (h) for the entering object (o). Then ask if exit data is already recorded for existing journey history (h). If no, then update journey history (h) with time of entry (t) as exit time (leaving exit location as “unknown”). Finally, for all of the previous cases proceed to create a journey history for the entering object (o) containing the entry location (n) and time of detection (t).

In another example processing an object exit event could include first testing if an existing journey history exists for the exiting object (o). If yes, retrieve most recent journey history (h) for the exiting object (o) and ask if exit data is already recorded for existing journey history (h). If yes, or the answer to the first question was no, then create a new journey history (h) for the object (o). Then for all cases update journey history (h) with node (n) as location of exit and time (t).

In the above examples, the journey history may also store the start of the detection time period and the end of the detection time period rather than just a detection time (and similar for entry and exit times).

The next section of the specification describes the Visit Feasibility query and analysis processes using the previously recorded data relating to objects and transportation means operating within a network of connected nodes.

The Visit Feasibility Query functionality determines whether or not it is feasible for an object to have visited a nominated node between specified times based only on knowledge of where and when the object entered and/or exited the network, assisted by data accumulated relating to transportation means' movement history within the network.

Some examples of queries handled by the Visit Feasibility Query functionality include:
Is it possible for a given object to have visited a specified node if the object joined the network at node X at time T1 and left the network at node Y at time T2?
Is it possible for a given object to have visited a specified node at a specified time or during a specified period if the object joined the network at node X at time T1 and/or left the network at node Y at time T2?
Which objects could have visited a specified node between time T1 and time T2?
Which objects could have been present at a specified node for the entire duration T1 to T2?
Is it possible for a given object to have utilised transportation means Z during the object's journey between node X at time T1 and node Y at time T2?
Which objects could have utilised transportation means Z between time T1 and time T2?

Using the network depicted in FIG. 1 as an example, an object travelling from node N₁ to node N₁₃ can travel many different paths to reach its destination. Disregarding any path sequences that require a reversal of direction during its journey, the example network allows four different path sequences to be taken: {N₁, N₂, N₃, N₄, N₅, N₁₂, N₁₃}/{N₁, N₂, N₆, N₇, N₈, N₉, N₁₀, N₅, N₁₂, N₁₃}, {N₁, N₂, N₆, N₇, N₈, N₉, N₁₁, N₁₃}, and {N₁, N₂, N₃, N₄, N₅, N₁₀, N₉, N₁₁, N₁₃}.

Using data gathered from actual transportation means' traversals within the network (including arrival and departure times of each transportation means at and from each node), a feasibility query can determine whether or not it was possible for a given object to have visited any node on the network within the available time given by the object's arrival at node N₁ and/or exit from node N₁₃.

Global Inputs by way of example in the embodiment include:
List of latest possible departure times from every node in the network, calculated for every transportation means arrival to every node.
History of node visits for each transportation means on the network.
Node or transportation means, and time range of interest (incident node/transportation means and time).
The entry and/or exit node and time for one or more objects utilising the network.

The output of such analysis is the subset of input objects that could have possibly been present at the node or on the transportation means of interest between a specified range of time which is of interest.

Transportation Means Incident Query

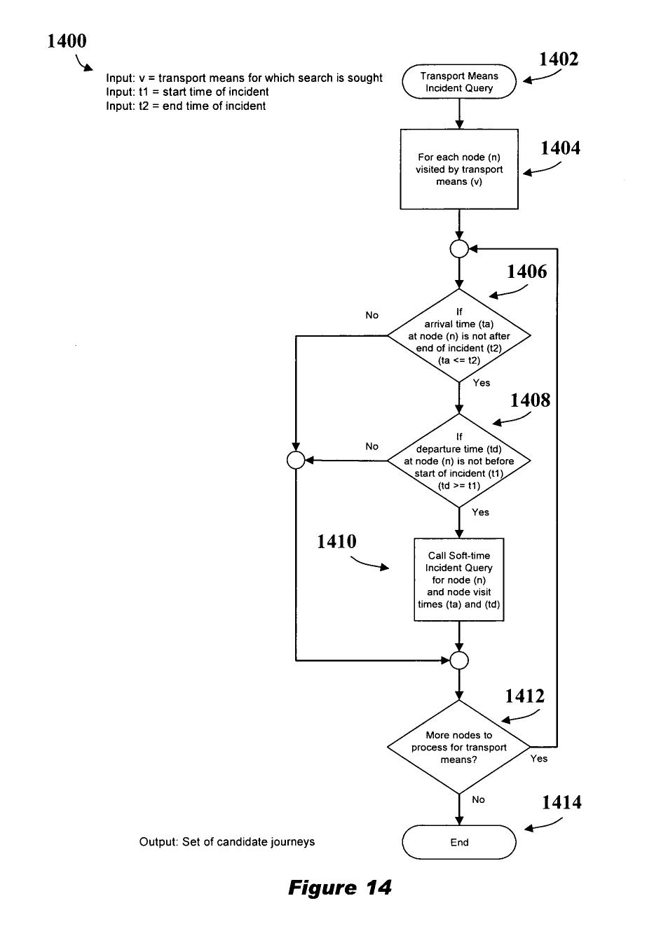

Given a transportation means and a time period, the Transportation Means Incident Query (1400) as depicted in FIG. 14 permits identification of each object that could have come into contact with the specified transportation means within the specified time period during their journey within the network.

FIG. 14 illustrates a flowchart (1400) of the Transportation Means Incident Query. The Transportation Means Incident Query (referred to as Transport Means Incident Query in 1402) has inputs v for the transportation means, and times t1 and t2 for start and end times of the incident. The algorithm cycles (1412, 1406) through each node (n) visited by transportation means (v) (1404). If the arrival time (ta) at node (n) is not after end of incident (t2) (ie ta<=t2) (1406), and if the departure time (td) at node (n) is not before the start of the incident (t1) (ie td>=t1) (1408) then call the Soft time Incident Query, which is discussed below, for node (n) and node visit times (ta) and (td) (1410). The soft time query is used to determine the subset of objects that could have reached node (n) during visit times (ta, td). If however the arrival time was after the end of the incident or the time of departure was before the start of the incident check if there are more nodes to process (1412, 1406) otherwise end (1414).

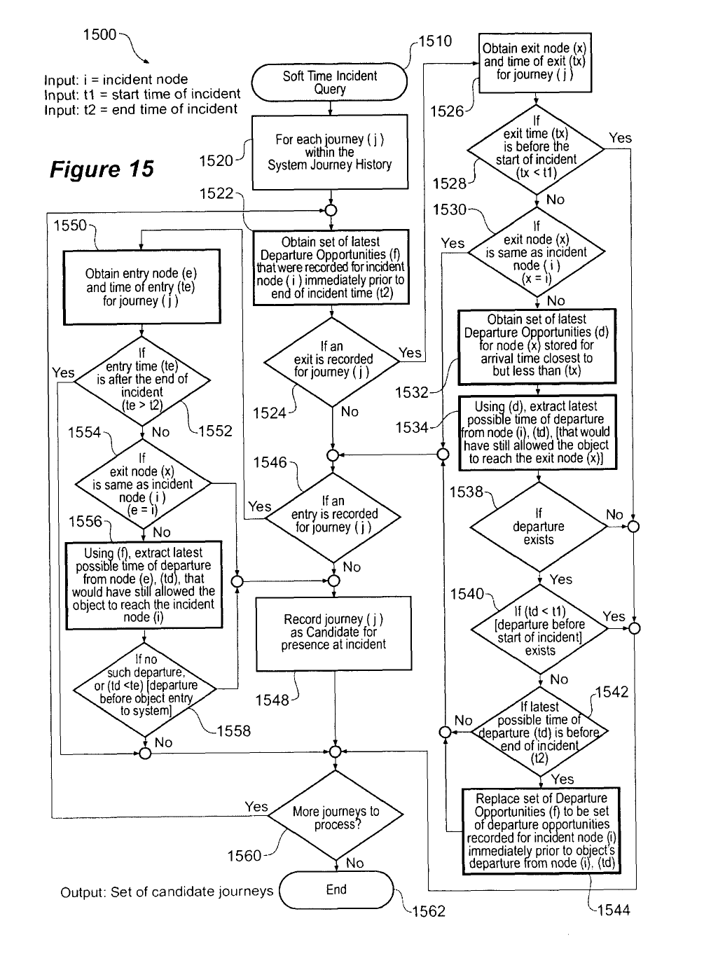

FIG. 15 depicts a Flowchart for a Soft-time Incident Query 1500.

The steps disclosed in FIG. 15 offers a method to determine the subset of objects that could have feasibly been present at a specified incident location at any time during the nominated incident period, based only on the object's entry and/or exit time to the network and their respective locations at those times (Nodes), and the set of latest possible departure times that have been gathered for transportation means arrivals at nodes on the network.

The steps works backwards in time using latest possible departure times to determine if a particular object's journey could be at or have been at the node of interest during the time of the incident. The incident may for example be a fire at a depot and damage and loss occurs to multiple packages such that they can not be identified. A yet further example is the determination of candidate objects lost in the network between certain times or determining if they could be at a certain node between certain times.

In FIG. 15 each journey (j) (refer to FIGS. 13a and 13b and associated description in the specification) describes the event of an object entry or exit or both and the collection of all journeys (j) forms the System Journey History (1520) from which candidates relevant to the incident are drawn. If an object is not recorded as having entered or exited the network then it is not considered as a candidate. In a Soft-time Incident Query (1510) the query includes three inputs: (i) the incident node, (t₁) the start time of the incident and (t₂) the end time of the incident.

The first narrowing of feasible objects to consider is achieved by (1522) specifying the incident node (n) and obtaining from the records, the set of Departure Opportunities (f) that are recorded for the incident node (n) immediately prior to the end of the incident time (t2).

If an exit of an object is associated with that journey (j) (1524) (i.e. what node was used for the object to exit the network) obtain (1526) the node x and at what time tₓ that exit occurred.

If that exit time (tₓ) is before the start time (t₁) of the incident (1528) then clearly that object is not a candidate.

If the opposite is true then, we determine if the exit node (x) the same as the incident node (i) (1530). If YES and no entry is recorded for journey j (1546), then that journey is a candidate for presence at the incident (1548). If yes and an entry is recorded for journey j then processing continues at 1550 as discussed below.

If the opposite is true, then if the exit node (x) is not the same as the incident node (i). We obtain the Departure Opportunities (d) for node (x) for arrival times closest to but less that than time (tₓ) (1532). This opens up the possibility that the object, the subject of a journey, arrived earlier but still left on a transportation means with sufficient time to have reached the exit node before the end time (t₂) of the incident (1534). If no departure exists (1538) then we do not consider the journey further.

Using the Departure Opportunities (d) it is possible to extract the possible time of departure (t_{d}) from node (i) that would have allowed the object to reach the exit node before (tₐ) (1540).

In the situation for which objects could have met this criteria and if they departed before the incident time (t₁), they are not a candidate (1540), but where that is not possible, the next test is whether the latest possible departure time is before (t₂), which is the end incident time (1542).

If yes then replace the set of departure opportunities (f) with the set of departure opportunities recorded for the incident node (i) immediately prior to object's departure from node (i), (t_{d}) (1544).

The next test is whether there is an entry record (1546). If not, that object and journey is automatically considered a candidate (1548). If there is an entry recorded, the details of the entry have to be tested further (1550).

If the entry time (tₑ) associated with the object is after the end of the incident time period (t₂), that object is not a candidate (1552).

If the entry time (tₑ) is not after (t₂), it may still be a candidate, but only if the next test (1554) determines that the entry node is the same as the incident node (i) (1548).

If not, the latest possible time of departure (t_{d}) is determined for the node entry (e) and it is determined if the object could have reached the incident node (i) (1556).

If that could not have occurred (1558) (i.e. there is no such departure or t_{d}<tₑ) then that object is not a candidate. If that is the case, the object is recorded as a candidate (1548).

The process is repeated until all object journeys are considered (1560) and the set of candidates has been determined (1562).

The output of the algorithm is a list of candidate journeys by objects. In an embodiment where parcels are damaged or lost, most of the candidates will correspond to those that are otherwise unidentifiable and their entry into the network will now be identifiable.

For an object such as parcels that are, at the time of the query, still in the network, but may have conceivably been at the incident node (i) between the incident start and end time, they may yet be delivered and, over time, can clearly be eliminated, but remain candidates until that is the case.

Rigid-Time Incident Query

This algorithm provides a method to determine the subset of objects that could have been present at a specified incident location node (i) for the entire nominated duration of the incident (between t₁ and t₂), based only on the object's entry and/or exit location (Node) and time of entry and/or exit to or from the network, and the set of latest possible departure times that have been associated with the transportation means' arrivals at nodes on the network.

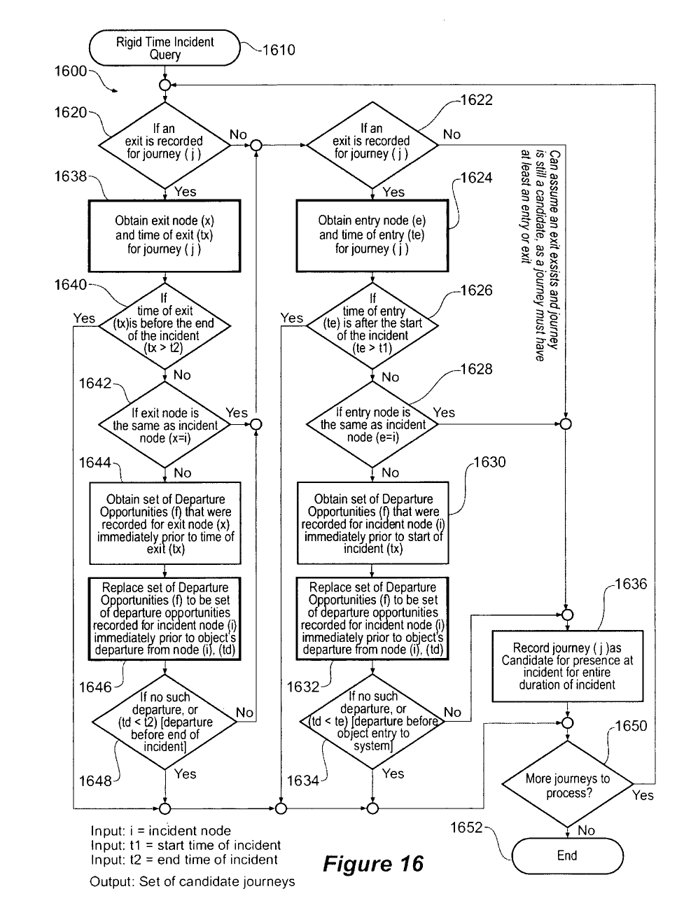

The steps (1600) depicted in FIG. 16 works backwards in time using latest possible departure times to determine if a particular object's journey could have taken the object to a node of interest for the duration of the incident, the output being the subset of objects (in the form of their journeys) that were at the incident node for the entire duration.

The rigid time incident query begins at (1610) with inputs (i) being the incident node and times (t₁) and (t₂) being the start and end incident times respectively. The query cycles through all the journeys to process (1650). For a given journey we first test if an exit is recorded for the journey (j) (1620). If a journey exists (yes) obtain exit node (x) and time of exit (tx) for journey (j) (1638).

If the time of exit (tx) is before the end of the incident the journey is not a candidate so proceed to the next node (1650). If not, check if the exit node is the same as the incident node (x=i) (1642). If yes proceed to step 1622 for further processing and if no (1644) obtain the set of departure opportunities (f) that were recorded for exit node (x) immediately prior to the time of exit (tx). Using (f) extract the latest possible time of departure from node (i) (td) that would have still allowed the object to reach the exit node (x) by tx (1646). If there is no such departure or td<t2 (ie departure before end of incident) (1648), the journey is not a candidate (1650), otherwise it may be a candidate and we proceed to step (1622).

At (1622) we check if a entry is recorded for journey (j). If no, then we assume the object could have entered any time from the start time of the network, so we record the journey as a candidate present for the entire duration of the incident (j) (1636).

If there is an entry recorded for journey (j) we obtain entry node (e) and time of entry (te)(1624). If the time of entry is after the start of the incident (te>t1) (1626) then the journey is not a candidate. Otherwise we first check if the entry node is the same as the incident node (1628) as if it is then the journey is a candidate (1636).

If the entry node is not the same as the incident node (1630), obtain the set of departure opportunities (f) that were recorded for incident node (i) immediately prior to the start of the incident (t1). Using (f) extract the latest possible time of departure from node (e) (td) that would have still allowed the object to reach the incident node (i) by (t1)(1632). If there is no such departure or td<te (ie departure before object entry into system) (1634), the journey is not a candidate (1650), otherwise record the journey as a candidate present for the entire duration of the incident (j) (1636).

Another Embodiment of the Soft Time Query

In another embodiment, a method for determining the subset of the zero or more objects detected entering, exiting or in the network that could have been at a predetermined location at any time during a predetermined time period includes the steps of
associating zero or more sets of times with each node in the network wherein each set of times includes a reference time and the latest possible time that an object could have departed each other node in the network and arrived at the node by the reference time; and
associating with each object detected in the network, one or more detection locations and associated detection time periods; and
associating one or more nodes with each detected and predetermined location.

This allows determination of the subset of the one or more objects that could have been at the predetermined location during the predetermined time period wherein for each detection location and detection time period associated with an object, by considering for each object, if the object could have been transported via zero or more object transportation means from a detection location at or after the start of the associated detection time, to arrive at the predetermined location at or before the end of the predetermined time period; or, if the object could have been transported via zero or more transportation means from the predetermined location at or after the start of the predetermined time period to arrive at a detection location at or before the end of the associated detection time. If the answer is true to either query then the object is a member of the subset of objects that could have been at the predetermined location during the predetermined time period.

This method may further include arranging each detection location and associated detection time period, and the predetermined location and predetermined time period, into chronological order.

Such ordering could be performed on the basis of the order of the start or end times of the time periods or it could be in forward or reverse order.

Each successive pair of the chronologically ordered pair of locations and associated time periods could then be processed. For example if there are 6location/time periods. Then five pairs: (1,2), (2,3), (3,4), (4,5) and (5,6) would be processed. In this case consider 4 to correspond to the predetermined location and time period.

If the pair of (locations/time periods) includes the predetermined location and predetermined time period as the least recent location and time in the pair (ie pair (4,5)) then if the detection location and predetermined location are the same, or if the object could have been transported via one or more object transportation means from the predetermined location at or after the start of the predetermined time period to arrive at the detection location at or before the start of the detection time period, then the object is a member of the subset of objects that could have been at the predetermined location during the predetermined time period.

That is consider the pair of times ((t₁′, t₂′)ᵢ, (t₁″,t₂″)ⱼ). In this case the pair (t₁′, t₂′)ᵢ corresponds to the predetermined node (i) and the predetermined timer period (t₁, t₂). We first considers if (i=j), in which case the detection node and predetermined (incident) node are the same. In this case the object was detected at the node before the incident time (as the records are time ordered) and thus the object is a candidate. If the nodes are different (i≠j), then we ask if t_{d,j}<t₁″

If the pair includes the predetermined location and predetermined time period as the most recent location and time in the pair (ie pair (3,4)) then if the detection location and predetermined location are the same or if the object could have been transported via one or more object transportation means from the detection location at or after the end of the detection time period to arrive at the predetermined location at or before the end of the predetermined time period then the object is a member of the subset of objects that could have been at the predetermined location during the predetermined time period.

This method can be further adapted if the predetermined location is a transportation means. In this case for each transportation means, we obtain the records of each node visited by the transportation means together with an associated time of arrival and departure by the transportation means at the respective node.

To handle this case we need to replace the predetermined location and its associated time period with one or more replacement locations and associated time periods whereby each replacement location corresponds to a node in the network and each replacement associated time period is a non-overlapping segment of the original predetermined time period.

If the transportation means remains at a node for the entire duration of the predetermined time period then the node is associated with the replacement location and the testing is performed as above.

If the transportation means is between nodes for the entire duration of the predetermined time period then the node from which the transportation means departed immediately prior to the start of the predetermined time period is associated with the replacement location, and the start of the predetermined time period is set to a time immediately prior to the time of departure by the transportation means from the node, and the end of the predetermined time period is set to the time of departure by the transportation means from the node. Again the testing is performed as above with this replacement location and time period in place of the predetermined location and time period.

If the transportation means visited at least one node during the predetermined time period then we must consider each node visited by the transportation means. In the case that the start of the original predetermined time period is after the time of arrival by the transportation means at the node then a replacement location and associated time period is defined with its location associated with the node, and its associated time period commencing at the start of the original predetermined time period and ending at the time of departure by the transportation means from the node.

Otherwise if the end of the original predetermined time period is before the time of departure by the transportation means from the node then a replacement location and associated time period is defined with its location associated with the node and its associated time period commencing at the time of arrival by the transportation means at the node and ending at the end of the original predetermined time period.

Finally if the previous two conditions are not satisfied then a replacement location and associated time period is defined with its location associated with the node and its associated time period commencing at the time of arrival by the transportation means at the node and ending at the time of departure by the transportation means from the node.

The above method for determining if an object was at the predetermined location during the predetermined timer period is performed for each of the replacement locations and time periods wherein for each case the replacement location and time period replaces the predetermined location and time period.

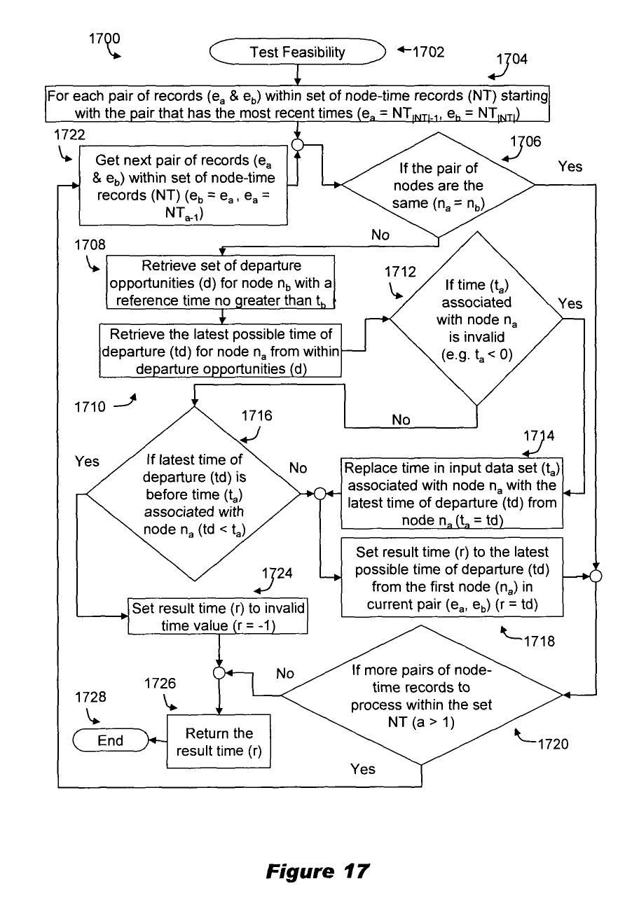

Aspects of the above method are further illustrated in FIG. 17, which is a flowchart of a method for processing a time ordered set of node-time records to determine if the set could have been traversed. The time ordered node-time records could be a set of NodeVisits associated with a transportation means and a node-time pair associated with the predetermined location and associated time.

The output is the latest possible time that any object could have departed the first node (n₁) in the set of node-time records (NT) and sequentially visited and departed each interim node (n₂ . . . n_{|NT|-1}) no earlier than the time (tₓ) associated with each respective interim node (nₓ) to arrive at the last node (n_{|NT|}) no later than the time (t_{|NT|}); or an invalid time if the traversal was not possible. In this embodiment if one of the node time pair corresponds to the predetermined location and associated time this can be used to assess feasibility that an objects that could have been at the predetermined location during the predetermined time period.

In this FIG. 17 NT is the set of two or more ordered node and time records where: NT={e₁, e₂, . . . , e_{|NT|}} and where eₓ=[nₓ, tₓ] (ie a node and time where tₓ is a time associated with node nₓ;). We also have that t_{1 . . . (|NT|-1)} may be invalid times, t_{|N|} must be a valid time and tₓ₋₁<=tₓ<=tₓ₊₁, or implied as such if tₓ is invalid.

For each pair of records(eₐ & e_{b}) within set of node-time records (NT) starting with the pair that has the most recent times (eₐ=NT_{|NT|-1}, e_{b}=NT_{|NT|}) (1704).

We check if the pair of nodes are the same (nₐ=n_{b}) (1706). If not (1708) then retrieve the set of departure opportunities (d) for node n_{b} with a reference time no greater than t_{b} Next (1710) retrieve the latest possible time of departure (td) for node nₐ from within departure opportunities (d) and then determine if time (tₐ) associated with node nₐ is invalid (e.g. Tₐ<0) (1712). If yes (1714) replace time in input data set (tₐ) associated with node nₐ with the latest time of departure (td) from node nₐ (tₐ=t_{d}) and then set the result time (r) to the latest possible time of departure (td) from the first node (nₐ) in the current pair (eₐ, e_{b})(r=td) (1724). If no (1716) determine if the latest time of departure (td) is before time (tₐ) associated with node nₐ (td<tₐ). If no then set the result time (r) to the latest possible time of departure (td) from the first node (nₐ) in the current pair (eₐ, e_{b})(r=td) (1724).
If the pair of nodes was the same (nₐ=n_{b}) (1706) or if we have performed (1718) determine if there are more pairs of node-time records to process within the set NT (a>1) (1720). If yes, then get next pair of records (eₐ & e_{b}) within the set of node-time records (NT) (e_{b}=eₐ, eₐ=eₐ=Ntₐ₋₁) (1722) and again check if the pair of nodes are the same (nₐ=n_{b}) (1706). If no, then set result time (r) to invalid time value (r=−1) (1724) and return the result time (r) (1726) and end (1728).

If the latest time of departure (td) is before time (tₐ) associated with node nₐ (td<tₐ), then set result time (r) to invalid time value (r=−1) (1724) and return the result time (r) (1726) and end (1728).

The output is the latest possible time that any object could have departed the first node (n₁) in the set of node-time records (NT) and sequentially visited and departed each interim node (n₂ . . . n_{|NT|-1}) no earlier than the time (tₓ) associated with each respective interim node (nₓ) to arrive at the last node (n_{|NT|}) no later than the time (t_{|NT|}); or an invalid time if the traversal was not possible.

Another Embodiment of the Rigid Time Query

The above approach can also be adapted to a rigid time query in which we wish to determine the subset of the zero or more objects detected entering, exiting or in the network that could have been at a predetermined location for the entire duration of a predetermined time period.

This method includes the steps of:
associating zero or more sets of times with each node in the network wherein each set of times includes a reference time and the latest possible time that an object could have departed each other node in the network and arrived at the node by the reference time; and
associating with each object detected in the network, one or more detection locations and associated detection time periods; and
associating one or more nodes with each detected and predetermined location.

Determining the subset of the one or more objects that could have been at the predetermined location for the entire duration of a predetermined time period requires determining, for each detection location and detection time period associated with an object, whether if the object could have been transported via zero or more object transportation means from the detection location at or after the start of the associated detection time, to arrive at the predetermined location at or before the start of the predetermined time period and whether if the object could have been transported via zero or more transportation means from the predetermined location at or after the end of the predetermined time period to arrive at a detection location at or before the end of the associated detection time. If both queries are true, then the object is a member of the subset of objects that could have been at the predetermined location for the entire duration of a predetermined time period.

The method may further include ordering each detection location and associated detection time that have been associated with the object and the predetermined location and predetermined time period, into chronological order; and processing each successive pair of the chronologically ordered pair of locations and associated time periods.

Only the pairs including the predetermined location and predetermined time period are required to determine if the object is a member of the subset of objects that could have been at the predetermined location for the entire duration of a predetermined time period. For such a pair, the object is a member of the subset if the two detection locations are the same, or if the object could have been transported via one or more object transportation means from the least recent of the two detection locations at or after the end of the least recent associated detection time to arrive at the more recent of the two detection locations at or before the start of the more recent associated detection time.

This may be adapted for the case that the predetermined location is a transportation means. In this case for each transportation means, we obtain the records of each node visited by the transportation means together with an associated time of arrival and departure by the transportation means at the respective node.

The predetermined location and its associated time period is processed to obtain one or more replacement locations and associated time periods whereby each replacement location corresponds to a node in the network and each replacement associated time period is a non-overlapping segment of the original predetermined time period.

If the transportation means remains at a node for the entire duration of the predetermined time period then the node is associated with as the replacement location and the above steps are performed.

If the start of the predetermined time period is during a period when the associated transportation means is in transit between nodes then, the replacement location and associated time period is defined with the replacement location associated with the node of departure, by the transportation means immediately prior to the start of the original associated time period and the replacement associated time period will commence immediately before the time of departure of the transportation means from the departure node and ending at the time of departure of the transportation means from the departure node.

If the end of the predetermined time period is during a period when the associated transportation means is in transit between nodes then the replacement location and associated time period is defined with the location associated with the node at which the transportation means will arrive immediately after the end of the original predetermined time period, and the replacement associated time period will commence at the time of arrival of the transportation means at the arrival node and ending immediately after the time of arrival of the transportation means at the arrival node.

If the start of the predetermined time period is during a period when the associated transportation means is at a node then the replacement location is associated with the node, and the associated replacement time period commences at the start of the original associated time period and ends at the time of departure of the transportation means from the node.

If the end of the predetermined time period is during a period when the associated transportation means is at a node then the replacement location is associated with the node, and the replacement associated time period commences at the time of arrival of the transportation means at the node and ends at the end of the original associated time period.

An Embodiment of a Visit Feasibility Query

In another embodiment a method for determining the feasibility of an object being able to transit from one predetermined location at an associated time to a second predetermined location at a second associated time via zero or more other predetermined locations that also have an associated time is described below. The method includes the steps of:
associating zero or more sets of times with each node in the network wherein each set of times includes a reference time and the latest possible time that an object could have departed each other node in the network and arrived at the node by the reference time; and
associating each predetermined location and its associated time as one or more predetermined locations and associated times that are each associated with a single node; and
   arranging the set of predetermined locations and associated times into chronological order of associated times; and
for each adjacent pair of predetermined locations in the chronologically ordered set, starting with the most recent and second most recent predetermined locations: using the zero or more sets of times associated with each node in the network to determine if an object could have been transported via zero or more object transportation means from the least recent predetermined location in the pair at or after the start of the least recent associated predetermined time, to arrive at the more recent predetermined location in the pair at or before the end of the more recent associated predetermined time; and
if traversal between all pairs of predetermined locations considered above were possible within the respective predetermined times, that traversal of the set of predetermined locations at the associated predetermined times is determined to be feasible.
   In the above method any predetermined time may be expressed as either a discrete time or time period.

In another embodiment a method for determining the feasibility of an object being able to transit from one predetermined location at an associated time to a second predetermined location at a second associated time via zero or more other predetermined locations that may or may not have an associated time is described below. The method includes the steps of:
a) associating zero or more sets of times with each node in the network wherein each set of times includes a reference time and the latest possible time that an object could have departed each other node in the network and arrived at the node by the reference time; and
b) associating each predetermined location and its associated time (if any) as one or more predetermined locations and associated times that are each associated with a single node; and
c) arranging the set of predetermined locations and associated times into a predetermined order of object traversal between predetermined locations such that each adjacent pair of predetermined locations represents an origin and destination of a segment of a larger journey; and
d) assigning a predetermined time to the last predetermined location if no such time was associated with the last predetermined location; and
e) for each adjacent pair of predetermined locations in the ordered set (referred to below as departure and arrival locations), starting with the last and second to last predetermined locations:
   i) using the zero or more sets of times associated with each node in the network to determine the latest possible time that an object could have departed the origin location and arrived at the destination location by the end of the destination's associated time; and
   ii) if the departure location has no associated time, assigning the latest possible departure time as the departure location's associated time; and
   iii) if the departure location already has an associated time, checking that the latest possible time obtained above is no later than the departure location's associated time (otherwise the traversal is not feasible); and
f) if no further adjacent pairs of predetermined locations are left to consider, then that traversal of the set of predetermined locations at the associated predetermined times (if any) is determined to be feasible.
   In the above method any predetermined time may be expressed as either a discrete time or time period.

Forward Time Embodiment

In one embodiment, a Departure Arrivals could be associated with nodes or transport means rather than Departure Opportunities. Departure Arrivals are a set of times associated with a node which include a reference time and the earliest possible time that an object could have arrived at each other node in the network having been at the current node at the reference time. Effectively Departure Opportunities look back in time (ie fastest time to arrive here), whilst Departure Arrivals look forward time (ie fastest time to get from here to somewhere else). It will be apparent that Departure Arrivals may be associated with transportation means, and the merge and updating processes between nodes and transport means for Departure Opportunities may be adapted to Departure Arrivals. Preferably departure arrivals are associated with a node each time a transportation means departs a node. Updating the set of times associated with a transportation means is performed for each time a transportation means arrives at a node, and merging of times between the transportation means and node is performed when the transportation means arrives at the node (ie just prior to associating a set of times with the node). Testing of object entry and exit times is also slightly modified for departure arrivals, although the underlying concepts are the same (ie could the object have arrived at, or departed the node during the time point of interest).

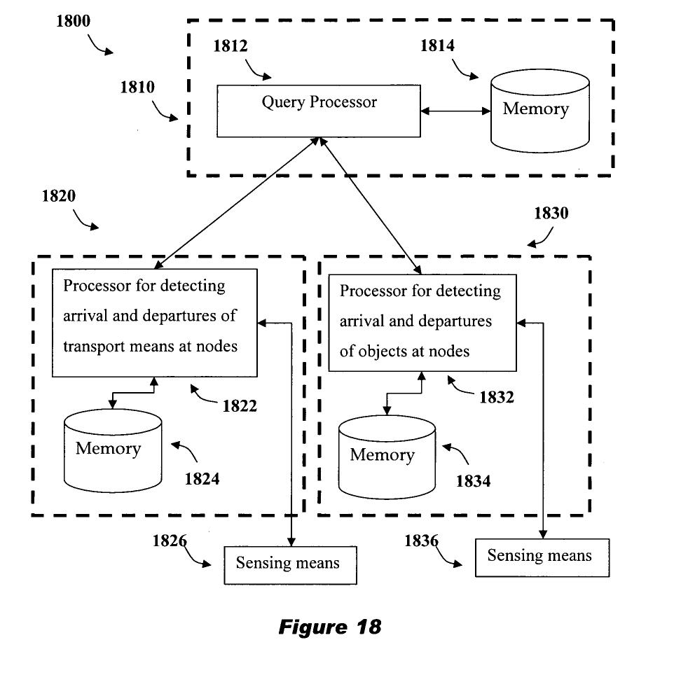

The various steps and associated flowcharts have been described in a manner that a person skilled in the art could use to program a general purpose computer to perform. FIG. 18 discloses a system 1800 to assist in the performance of one more methods disclosed herein. A query processor (1812) with associated memory (1814) is programmed to perform the steps of any of the above methods. A query processor is in communication with a processor for detecting arrival and departures of transportation means at nodes (1822). The query processor is also in communication with a processor for detecting arrival and departures of objects at nodes (1832). The dashed lines 1810, 1820 and 1830 indicate that the processors are physically separated from each other. It is to be understood that the individual processors could be co-located, or they may be distributed processors. The nature of communication could be via a dedicated wired or wireless link. Alternatively information generated by one processor could be stored on a physical storage means and transferred, or communicated to the memory 1814 associated with the query processor 1812.

The processor for detecting arrival and departures of transportation means at nodes (1822) is in communication with a memory (1824) and a sensing means (1826). The dashed line (1820) indicates that the processor is physically separated from the sensing means (1826), but is in communication with it. Similarly the processor for detecting arrival and departures of objects at nodes (1832) is in communication with a memory (1834) and a sensing means (1836). The dashed line (1830) indicates that the processor is physically separated from the sensing means (1836), but is in communication with it. Note that sensing means could be co-located with processors, or may include processing and storage means in addition to a sensor. Also note that detections could be made outside of arrivals and departures, such as when transportation means or objects are in transit in the network. Note that in some cases where interest is only in time periods during which movement between locations was feasible, the processor for detecting arrival and departures of objects at nodes (1832) is not required for performing the queries of interest

The above embodiments illustrate various aspects of the invention. However it will be apparent to the person skilled in the art that the data structures above and methods and steps are exemplary examples. Various alternative approaches may be used. In the above example Departure Opportunities are described which are a set of times with associated with a node. The set of times includes a reference time and the latest possible time that an object could have departed each other node in the network and arrived at the node by the reference time. Storing this information and using transportation means and nodes to exchange departure opportunities provides the basis for various methods for determining the feasibility of transporting objects around the network.

Although a preferred embodiment of the method and system of the present invention has been described in the foregoing detailed description, it will be understood that the invention is not limited to the embodiment disclosed, but is capable of numerous rearrangements, modifications and substitutions without departing from the scope of the invention as set forth and defined by the following claims.

1. A method for determining, in an object transportation network having one or more transportation means that transport at discernible times zero, one or more objects between nodes of the network via paths joining adjacent nodes of the network, the subset of the one or more objects that could have been at a predetermined location during a predetermined time period, the method including the steps of:
a) determining for each node of the network, the time period during which an object could have been transported to the predetermined location from the node, wherein said transportation occurred prior to or during the predetermined time period;
b) determining for each node of the network, the time period during which an object could have been transported from the predetermined location to the node, wherein said transportation occurred during or after the predetermined time period; and
c) determining the subset of the one or more objects that could have been at the predetermined location during the predetermined time period wherein if:
an object was at a node during a time period defined by the method steps a) or b) for the node; or
an object was on a transportation means and was transported to or from a node during a time period defined by the method steps a) or b) for the node;
then the object is a member of the subset of objects that could have been at the predetermined location during the predetermined time period.

2. A method for determining, in an object transportation network having one or more transportation means that transport at discernible times zero, one or more objects between nodes of the network via paths joining adjacent nodes of the network, the subset of the one or more objects that could have been at a predetermined location during a predetermined time period, the method including the steps of:
a) determining for each transportation means in the network, the time period during which an object on the transportation means could have been transported to the predetermined location by one or more transportation means, wherein said transportation occurred prior to or during the predetermined time period;
b) determining for each transportation means in the network, the time period during which an object could have been transported from the predetermined location to the transportation means by one or more transportation means, wherein said transportation occurred during or after the predetermined time period; and
c) determining the subset of the one or more objects that could have been at the predetermined location during the predetermined time period, wherein if:
an object was detected at a node that a transportation means arrived at, or departed from, during a time period defined by the method steps a) or b) for the transportation means; or
an objected was detected on a transportation means during a time period defined by the method steps a) or b) for the transportation means;
then the object is a member of the subset of objects that could have been at the predetermined location during the predetermined time period.

3. A method for determining, in an object transportation network having one or more transportation means that transport at discernible times zero, one or more objects between nodes of the network via paths joining adjacent nodes of the network, the subset of the one or more objects that could have been at a predetermined location during a predetermined time period, the method including the steps of:
a) associating one or more nodes with the predetermined location
b) associating at least one detection location and detection time period with each object detected entering, exiting or in the network;
c) associating a set of times with a node, wherein the set of times includes a reference time and the latest possible time that an object could have departed each other node in the network and arrived at the node by the reference time, and wherein zero, one or more sets of times are associated with each node of the network; and
d) determining the subset of the one or more objects that could have been at the predetermined location during the predetermined time period wherein if,
at least one associated detection location and time period for the object and at least one of the zero, one or more sets of times associated with each node in the network permit the object to be transported to or from the one or more nodes associated with the predetermined location, said transportation to occurring prior to or during the predetermined time period, and said transportation from occurring during or after the predetermined time period
then the object is a member of the subset of objects that could have been at the predetermined location during the predetermined time period.

4. A method as claimed in claim 3, wherein the reference time is the time of arrival of a transportation means at the node.

5. A method as claimed in claim 4, including the further steps before step d):
e) associating a set of times with each transportation means, wherein each set of times associated with a transportation means includes a reference time and the latest known time that an object could have departed each node in the network prior to the reference time;
f) updating the set of times associated with a transportation means each time a transportation means departs a node, wherein the reference time is the time of departure, and the set of times is updated based upon the set of times associated with the departure node having a reference time closest in time before or equal to the time of departure; and
wherein the set of times associated with a node when a transportation means arrives at the node is obtained from merging the set of times associated with the transportation means and the set of times associated with the node having a reference time closest in time prior to the arrival of the transportation means, wherein merging is performed such that the time associated with each other node is the most recent time from the two sets of times.

6. A method as claimed in claim 5, wherein step b) of associating at least one detection location and detection time period with each object detected entering, exiting or in the network includes:
associating at least one journey history record with each detected object, each journey history record including:
at least one possible entry node and associated entry time for the object; and
at least one possible exit node and associated exit time for the object;
wherein in step d) a journey history record is used to determine if least one associated detection location and time period for the object and at least one of the zero, one or more sets of times associated with each node in the network permit the object to be transported to or from the one or more nodes associated with the predetermined location.

7. A method as claimed in claim 6 wherein if the associated object was detected entering the network, then the at least one possible entry node and associated entry time is the detected entry node and end of the detected entry time period, and if the associated object was detected exiting the network, then the at least one possible exit node and associated exit time is the detected exit node and start of the detected exit time period.

8. A method as claimed in claim 6 wherein the at least one possible entry node and associated entry time includes all nodes, and the associated entry time for each node is a predetermined network start time.

9. A method as claimed in claim 6 wherein the at least one default possible exit node and associated exit time includes all nodes, and the associated exit time for each node is a predetermined network end time.

10. A method as claimed in claim 6 wherein the at least one possible entry node and associated entry time includes all nodes, and the associated entry time for each node is the time that network services started at that node.

11. A method as claimed in claim 6 wherein the at least one possible exit node and associated exit time includes all nodes, and the associated exit time for each node is the time that network services ended at that node.

12. A method as claimed in claim 3 or 6, wherein step a) further includes:
determining if the predetermined location corresponds to a node; a transportation means, or a path between two nodes, wherein
if the predetermined location corresponds to a node, then the associated one or more nodes is the corresponding node, or if the predetermined location corresponds to a transportation means, then the associated one or more nodes includes the node the transportation means departed immediately prior to the start of the predetermined time period, or if the predetermined location corresponds to a location on a path between adjacent nodes, the one or more nodes includes at least one of the nodes associated with the path.

13. A method as claimed in claim 6 or 12, wherein the step of determining if an object is a member of the subset of objects that could have been at the predetermined location during the predetermined time period includes determining if, for any of the one or more nodes associated with the predetermined location, and for any of the at least one possible entry node associated with the object:
the time associated with the possible entry node is equal to or prior to the time corresponding to the associated entry node in the set of times having a reference time closest in time prior or equal to the end of the predetermined time for the current node associated with the predetermined location,
or if for any of the one or more nodes associated with the predetermined location, and for any possible exit node associated with the object,
the start of the predetermined time period is equal to or after the time corresponding to the time associated with the current node associated with the predetermined location in the set of times associated with the possible exit node having a reference time closest in time prior or equal to the associated exit time.

14. A method as claimed in claim 5, wherein step b) of associating at least one detection location and detection time period with each object detected entering, exiting or in the network includes:
associating a prior node and associated prior time with the object, wherein the prior node and prior time are the node and time associated with the more recent detection of the object prior to the start of the predetermined time period; and
associating a post node and associated post time with the object, wherein the post node and post time are the node and time associated with the more recent detection of the object after the end of the predetermined time period; and
wherein the step of determining if:
an object is a member of the subset of objects that could have been at the predetermined location during the predetermined time period includes determining if:
for any of the one or more nodes associated with the predetermined location, the prior time associated with the prior node for the object is equal to or prior to the time corresponding to the associated prior node in the set of times having a reference time closest in time prior or equal to the end of the predetermined time for the current node associated with the predetermined location,
or, if, for the post node associated with the object and the current node associated with the predetermined location, the start of the predetermined time period is equal to or after the time corresponding to the time associated with the current node associated with the predetermined location in the set of times associated with the post node having a reference time closest in time prior or equal to the associated post time.

15. A method as claimed in claim 6, wherein step d) includes:
for each node associated with the predetermined location processing each journey history record by:
selecting the set of times associated with the current node having an associated reference time which is the closest in time before, or equal to the end of the predetermined time period;
for each possible exit node and associated exit time in the current journey history record:
if the current associated exit time is before the start time of the predetermined time period then proceeding to the next possible exit node and associated exit time in the current journey history record, or the next journey history record if the there are no more possible exit nodes and associated exit times in the current journey history record;
else determining the latest possible time that an object could have traveled from the current node to the possible exit node by using the selected set of times associated with the exit node having an associated reference time which is the closest in time prior, or equal to the associated exit time; and,
if the latest possible time that an object could have traveled from the current node to the possible exit node is before the start time of the predetermined time period then proceeding to the next possible exit node and associated exit time in the current journey history record, or the next journey history record if there are no more possible exit nodes and associated exit times in the current journey history record;
else if the latest possible time that an object could have traveled from the current node to the possible exit node is before the end of the predetermined time period then replacing the currently selected set of times with the set of times associated with the current node having an associated reference time which is the closest in time prior, or equal to the obtained latest possible time that an object could have traveled from the current node to the possible exit node; and
for each possible entry node and associated entry time in the current journey history record:
if the associated entry time is after the end time of the predetermined time period then proceeding to the next possible entry node and associated entry time in the current journey history record, or the next journey history record if there are no more possible entry nodes and associated entry times in the current journey history record;
else determining the latest possible time that an object could have traveled from the possible entry node to the current node by using the selected set of times associated with current node; and
if the latest possible time that an object could have traveled from the possible entry node to the current node is before the associated entry time then proceeding to the next possible entry node and associated entry time in the current journey history record or the next journey history record if there are no more possible entry nodes and associated entry times in the current journey history record;
then the object is a member of the subset of objects that could have been at the predetermined location during the predetermined time period.

16. A method for determining, in an object transportation network having one or more transportation means that transport at discernible times zero, one or more objects between nodes of the network via paths joining adjacent nodes of the network, the subset of the one or more objects that could have been at a predetermined location during the entire duration of the predetermined time period, the method including the steps of:
a) associating one or more nodes with the predetermined location
b) associating at least one detection location and detection time period with each object detected entering, exiting or in the network;
c) associating a set of times with a node, wherein the set of times includes a reference time and the latest possible time that an object could have departed each other node in the network and arrived at the node by the reference time, and wherein zero, one or more sets of times are associated with each node of the network; and
d) determining the subset of the one or more objects that could have been at the predetermined location during the predetermined time period wherein an object is a member of the subset of objects that could have been at the predetermined location during the predetermined time period if at least one associated detection location and time period for the object and at least one of the zero, one or more sets of times associated with each node in the network permit the object to be transported to one of the one or more nodes associated with the predetermined location, said transportation to occurring prior to or equal to the start of predetermined time period and permit the object to be transported from the node and said transportation from occurring at or after the end of the predetermined period.

17. A method as claimed in claim 16, wherein the reference time is the time of arrival of a transportation means at the node.

18. A method as claimed in claim 17, including the further steps before step d):
e) associating a set of times with each transportation means, wherein each set of times associated with a transportation means includes a reference time and the latest known time that an object could have departed each node in the network prior to the reference time;
f) updating the set of times associated with a transportation means each time a transportation means departs a node, wherein the reference time is the time of departure, and the set of times is updated based upon the set of times associated with the departure node having a reference time closest in time before or equal to the time of departure; and
wherein the set of times associated with a node when a transportation means arrives at the node is obtained from merging the set of times associated with the transportation means and the set of times associated with the node having a reference time closest in time prior to the arrival of the transportation means, wherein merging is performed such that the time associated with each other node is the most recent time from the two sets of times.

19. A method as claimed in claim 18, wherein step b) of associating at least one detection location and detection time period with each object detected entering, exiting or in the network includes:
associating at least one journey history record with each detected object, each journey history record including:
at least one possible entry node and associated entry time for the object; and
at least one possible exit node and associated exit time for the object;
wherein in step d) a journey history record is used to determine if least one associated detection location and time period for the object and at least one of the zero, one or more sets of times associated with each node in the network permit the object to be transported to or from the one or more nodes associated with the predetermined location.

20. A method as claimed in claim 19 wherein if the associated object was detected entering the network, then the at least one possible entry node and associated entry time is the detected entry node and end of the detected entry time period, and if the associated object was detected exiting the network, then the at least one possible exit node and associated exit time record is the detected exit node and start of the detected exit time period.

21. A method as claimed in claim 19 wherein the at least one possible entry node and associated entry time includes all nodes, and the associated entry time for each node is a predetermined network start time.

22. A method as claimed in claim 19 wherein the at least one default possible exit node and associated entry time includes all nodes, and the associated exit time for each node is a predetermined network end time.

23. A method as claimed in claim 19 wherein the at least one possible entry node and associated entry time includes all nodes, and the associated entry time for each node is the time that network services started at that node.

24. A method as claimed in claim 19 wherein the at least one possible exit node and associated exit time includes all nodes, and the associated exit time for each node is the time that network services ended at that node.

25. A method as claimed in claim 16 or 19, wherein step a) further includes:
determining if the predetermined location corresponds to a node; a transportation means, or a path between two nodes, wherein
if the predetermined location corresponds to a node, then the associated one or more nodes is the corresponding node, or if the predetermined location corresponds to a transportation means, then the associated one or more nodes includes the node the transportation means departed immediately prior to the start of the predetermined time period, or if the predetermined location corresponds to a location on a path between adjacent nodes, the one or more nodes includes at least one of the nodes associated with the path.

26. A method as claimed in claim 19 or 25, wherein the step of determining if
an object is a member of the subset of objects that could have been at the predetermined location during the entire duration of the predetermined time period includes determining
if, for any of the one or more nodes associated with the predetermined location, and for any of the at least one possible entry node associated with the object, the time associated with the possible entry node for the object is equal to or prior to the time corresponding to the associated entry node the set of times having a reference time closest in time prior or equal to the start of the predetermined time for the current node associated with the predetermined location,
and, if, for any of the one or more nodes associated with the predetermined location, and for any possible exit node associated with the object, the end of the predetermined time period is equal to or after the time corresponding to the time associated with the current node associated with the predetermined location in the set of times associated with the possible exit node having a reference time closest in time prior or equal to the associated exit time.

27. A method as claimed in claim 18, wherein step b) of associating at least one detection location and detection time period with each object detected entering, exiting or in the network includes:
associating a prior node and associated prior time with the object, wherein the prior node and prior time are the node and time associated with the more recent detection of the object prior to the start of the predetermined time period; and
associating a post node and associated post time with the object, wherein the post node and post time are the node and time associated with the more recent detection of the object after the end of the predetermined time period; and
wherein in step d)
an object is a determined to be a member of the subset of objects that could have been at the predetermined location during the entire duration of the predetermined time period if,
for any of the one or more nodes associated with the predetermined location, and for prior time associated with the prior node associated with the object is equal to or prior to the time corresponding to the associated prior node in the set of times having a reference time closest in time prior or equal to the start of the predetermined time for the current node associated with the predetermined location,
and, for the post node associated with the object and the current node associated with the predetermined location, the end of the predetermined time period is equal to or after the time corresponding to the time associated with current node associated with the predetermined location in the set of times associated with the post node having a reference time closest in time prior or equal to the associated post time.

28. A method for determining, in an object transportation network having one or more transportation means that transport at discernible times zero, one or more objects between nodes of the network via paths joining adjacent nodes of the network, the subset of the one or more objects detected in the network that could have been at a predetermined location during a predetermined time period, the method including the steps of:
a) associating a journey with each object detected in the network, wherein the journey includes a entry location and associated entry time, and a exit location and associated exit time, and a entry node is associated with the entry location and an exit node is associated with the exit location; and
b) associating zero, one or more sets of times with each node of the network, wherein each set of times associated with a node of the network includes the latest possible time that an object could have departed each other node in the network and arrived at the associated node by an associated reference time;
c) associating a node with the predetermined location;
d) determining the subset of the one or more objects that could have been at the predetermined location during the predetermined time period wherein an object is a member of the subset of objects that could have been at the predetermined location during the predetermined time period if,
for each journey associated with an object, the associated entry time of an object is equal to or prior the time corresponding to the associated entry node in the set of times associated with the predetermined location having a reference time closest in time prior or equal to the end of the predetermined time; or
the start of the predetermined period is greater than or equal to the time corresponding to the node associated with the predetermined location in the set of times associated with the exit node having a reference time closest in time prior or equal to associated exit time.

29. A method for determining, in an object transportation network having one or more transportation means that transport at discernible times zero, one or more objects between nodes of the network via paths joining adjacent nodes of the network, the subset of the one or more objects detected in the network that could have been at a predetermined location during a predetermined time period, the method including the steps of:
a) associating a journey with each object detected in the network, wherein the journey includes a entry location and associated entry time, and a exit location and associated exit time, and a entry node is associated with the entry location and an exit node is associated with the exit location; and
b) associating zero, one or more sets of times with each node of the network, wherein each set of times associated with a node of the network includes the earliest possible time that an object could have arrived at each other node in the network having departed the associated node by an associated reference time;
c) associating a node with the predetermined location;
d) determining the subset of the one or more objects that could have been at the predetermined location during the predetermined time period wherein an object is a member of the subset of objects that could have been at the predetermined location during the predetermined time period if,
for each journey associated with an object, the associated exit time of an object is equal to or after the time corresponding to the associated entry node in the set of times associated with the predetermined location having a reference time closest in time equal to or after the start of the predetermined time; or
the end of the predetermined period is greater than or equal to the time corresponding to the node associated with the predetermined location in the set of times associated with the entry node having a reference time closest in time equal to after the associated entry time.

30. A method for determining, in an object transportation network having one or more transportation means that at discernable times, transport zero or more objects along paths between nodes of the network, the subset of the zero or more objects detected entering, exiting or in the network that could have been at a predetermined location at any time during a predetermined time period, the method including the steps of:
associating zero or more sets of times with each node in the network wherein each set of times includes a reference time and the latest possible time that an object could have departed each other node in the network and arrived at the node by the reference time; and
associating with each object detected in the network, one or more detection locations and associated detection time periods; and
associating one or more nodes with each detected and predetermined location; and
determining the subset of the one or more objects that could have been at the predetermined location during the predetermined time period wherein for each detection location and detection time period associated with an object:
if the object could have been transported via zero or more object transportation means from a detection location at or after the start of the associated detection time, to arrive at the predetermined location at or before the end of the predetermined time period; or
if the object could have been transported via zero or more transportation means from the predetermined location at or after the start of the predetermined time period to arrive at a detection location at or before the end of the associated detection time;
then the object is a member of the subset of objects that could have been at the predetermined location during the predetermined time period.

31. A method as claimed in claim 30, further including the steps of:
arranging each detection location and associated detection time period, and the predetermined location and predetermined time period, into chronological order; and the step of determining further includes
processing each successive pair of the chronologically ordered pair of locations and associated time periods wherein
if the pair includes the predetermined location and predetermined time period as the least recent location and time in the pair then if the detection location and predetermined location are the same or if the object could have been transported via one or more object transportation means from the predetermined location at or after the start of the predetermined time period to arrive at the detection location at or before the start of the detection time period then the object is a member of the subset of objects that could have been at the predetermined location during the predetermined time period; or
if the pair includes the predetermined location and predetermined time period as the most recent location and time in the pair then if the detection location and predetermined location are the same or if the object could have been transported via one or more object transportation means from the detection location at or after the end of the detection time period to arrive at the predetermined location at or before the end of the predetermined time period then the object is a member of the subset of objects that could have been at the predetermined location during the predetermined time period.

32. A method as claimed in claim 31, further including the steps of:
for each transportation means, recording each node visited by the transportation means together with an associated time of arrival and departure by the transportation means at the respective node; and
wherein if the predetermined location is a transportation means, the predetermined location and its associated time period is replaced by one or more replacement locations and associated time periods whereby each replacement location corresponds to a node in the network and each associated time period is a non-overlapping segment of the original predetermined time period such that:
a. if the transportation means remains at a node for the entire duration of the predetermined time period then the node is associated with the replacement location; otherwise
b. if the transportation means is between nodes for the entire duration of the predetermined time period then the node from which the transportation means departed immediately prior to the start of the predetermined time period is associated with the replacement location, and the start of the predetermined time period is set to a time immediately prior to the time of departure by the transportation means from the node, and the end of the predetermined time period is set to the time of departure by the transportation means from the node; otherwise
c. for each node visited by the transportation means during the predetermined time period:
i. if the start of the original predetermined time period is after the time of arrival by the transportation means at the node then a replacement location and associated time period is defined with its location associated with the node, and its associated time period commencing at the start of the original predetermined time period and ending at the time of departure by the transportation means from the node; and
ii. if the end of the original predetermined time period is before the time of departure by the transportation means from the node then a replacement location and associated time period is defined with its location associated with the node and its associated time period commencing at the time of arrival by the transportation means at the node and ending at the end of the original predetermined time period; and
iii. if the conditions in both (i) and (ii) are not satisfied then a replacement location and associated time period is defined with its location associated with the node and its associated time period commencing at the time of arrival by the transportation means at the node and ending at the time of departure by the transportation means from the node;
and wherein the step of determining is performed for each of the replacement locations and associated time periods wherein for each case the replacement location and associated time period replaces the predetermined location and time period.

33. A method for determining, in an object transportation network having one or more transportation means that at discernable times, transport zero or more objects along paths between nodes of the network, the subset of the zero or more objects detected entering, exiting or in the network that could have been at a predetermined location for the entire duration of a predetermined time period, the method including the steps of:
associating zero or more sets of times with each node in the network wherein each set of times includes a reference time and the latest possible time that an object could have departed each other node in the network and arrived at the node by the reference time; and
associating with each object detected in the network, one or more detection locations and associated detection time periods; and
associating one or more nodes with each detected and predetermined location; and
determining, the subset of the one or more objects that could have been at the predetermined location for the entire duration of a predetermined time period wherein for each detection location and detection time period associated with an object,
if the object could have been transported via zero or more object transportation means from the detection location at or after the start of the associated detection time, to arrive at the predetermined location at or before the start of the predetermined time period;
and if the object could have been transported via zero or more transportation means from the predetermined location at or after the end of the predetermined time period to arrive at a detection location at or before the end of the associated detection time
then the object is a member of the subset of objects that could have been at the predetermined location for the entire duration of a predetermined time period.

34. A method as claimed in claim 33, further including the steps of:
ordering each detection location and associated detection time that have been associated with the object and the predetermined location and predetermined time period, into chronological order; and
processing each successive pair of the chronologically ordered pair of locations and associated time periods wherein
if the pair includes the predetermined location and predetermined time period then if the two detection locations are the same or if the object could have been transported via one or more object transportation means from the least recent of the two detection locations at or after the end of the least recent associated detection time to arrive at the more recent of the two detection locations at or before the start of the more recent associated detection time,
then the object is a member of the subset of objects that could have been at the predetermined location for the entire duration of a predetermined time period

35. A method as claimed in claim 34, further including the steps of:
for each transportation means, recording each node visited by the transportation means together with an associated time of arrival and departure by the transportation means at the respective node; and
wherein if the predetermined location is a transportation means, the location and its associated time period are replaced by one or more replacement locations and associated time periods whereby each replacement location corresponds to a node in the network and each associated time period is a non-overlapping segment of the original predetermined time period such that:
a) if the transportation means remains at a node for the entire duration of the predetermined time period then the node is associated with the replacement location; otherwise
b) if the start of the predetermined time period is during a period when the associated transportation means is in transit between nodes then the replacement location and associated time period is defined with the replacement location associated with the node of departure by the transportation means immediately prior to the start of the original associated time period and the replacement associated time period commencing immediately before the time of departure of the transportation means from the departure node and ending at the time of departure of the transportation means from the departure node; or
c) if the start of the predetermined time period is during a period when the associated transportation means is at a node then the replacement location and associated time period is defined with the location associated with the node, and the replacement associated time period commencing at the start of the original associated time period and ending at the time of departure of the transportation means from the node; and
d) if the end of the predetermined time period is during a period when the associated transportation means is in transit between nodes then the replacement location and associated time period is defined with the location associated with the node to which the transportation means will arrive immediately after the end of the original predetermined time period, and the replacement associated time period commencing at the time of arrival of the transportation means at the arrival node and ending immediately after the time of arrival of the transportation means at the arrival node; or
e) if the end of the predetermined time period is during a period when the associated transportation means is at a node then the replacement location and associated time period is defined with the location associated with the node, and the replacement associated time period commencing at the time of arrival of the transportation means at the node and ending at the end of the original associated time period; and then
f) replacing the original predetermined location and associated time period with the one or more replacement predetermined locations and associated time periods created in steps (b) through (e) above;
and wherein the step of determining is performed for each of the replacement locations and associated time periods wherein for each case the replacement location and associated time period replaces the predetermined location and time period and the object is only added to the subset if it would be added for each replacement location and time period considered.

36. A method for determining, in an object transportation network having one or more transportation means that at discernable times, transport zero or more objects along paths between nodes of the network, the feasibility of an object being able to transit from one predetermined location at an associated time to a second predetermined location at a second associated time via zero or more other predetermined locations that also have an associated time, the method including the steps of:
a) associating zero or more sets of times with each node in the network wherein each set of times includes a reference time and the latest possible time that an object could have departed each other node in the network and arrived at the node by the reference time; and
b) representing each predetermined location and its associated time as one or more predetermined locations and associated times that are each associated with a single node; and
c) arranging the set of predetermined locations and associated times into chronological order of associated times; and
d) for each adjacent pair of predetermined locations in the chronologically ordered set, starting with the most recent and second most recent predetermined locations: using the zero or more sets of times associated with each node in the network to determine if an object could have been transported via zero or more object transportation means from the least recent predetermined location in the pair at or after the start of the least recent associated predetermined time, to arrive at the more recent predetermined location in the pair at or before the end of the more recent associated predetermined time; and
e) if traversal between all pairs of predetermine locations considered in step d) 0 were possible within the respective predetermined times, the set of predetermined locations at the associated predetermined times is determined to be feasible;
wherein, any predetermined time may be expressed as either a discrete time or time period.

37. A method for determining, in an object transportation network having one or more transportation means that at discernable times, transport zero or more objects along paths between nodes of the network, the feasibility of an object being able to transit from one predetermined location at an associated time to a second predetermined location at a second associated time via zero or more other predetermined locations that may or may not have an associated time, the method including the steps of:
a) associating zero or more sets of times with each node in the network wherein each set of times includes a reference time and the latest possible time that an object could have departed each other node in the network and arrived at the node by the reference time; and
b) representing each predetermined location and any associated time as one or more predetermined locations and associated times that are each associated with a single node; and
c) arranging the set of predetermined locations and associated times into a predetermined order of object traversal between predetermined locations such that each adjacent pair of predetermined locations represents an origin and destination of a segment of a larger journey; and
d) assigning a predetermined time to the last predetermined location if no such time was associated with the last predetermined location; and
e) for each adjacent pair of predetermined locations in the ordered set, associating the first location as a departure location and the second location as an arrival location, starting with the last and second to last predetermined locations:
i) using the zero or more sets of times associated with each node in the network to determine the latest possible time that an object could have departed the origin location and arrived at the destination location by the end of the destination's associated time; and
ii) if the departure location has no associated time, assigning the latest possible departure time as the departure location's associated time; and
iii) if the departure location already has an associated time, checking that the latest possible time obtain in the step of associating zero or more sets of times with each node in the network 0 is no later than the departure location's associated time; and
if no further adjacent pairs of predetermined locations exist, then traversal of the set of predetermined locations at the associated predetermined times is determined to be feasible;
wherein, any predetermined time may be expressed as either a discrete time or a time period.

38. A system for determining if one or more objects could have been at a predetermined location during a predetermined time period, the system including:
means for detecting an object at a location in the network, and recording the time of that detection;
means for detecting the location of a transportation means in the network, and recording the time of that detection; and
a processing means for performing the method of any one of claim 1,2,3, 16, 28, 29, 30 or 33 in response to a received query.

39. A system for determining the feasibility of an object being able to transit from one predetermined location at an associated time to a second predetermined location at a second associated time via zero or more other predetermined locations that also have an associated time if one or more objects that could have been at a predetermined location during a predetermined time period, the system including:
means for detecting the location of a transportation means in the network, and recording the time of that detection; and
a processing means for performing the method of claim 36 in response to a received query.

40. A system for determining the feasibility of an object being able to transit from one predetermined location at an associated time to a second predetermined location at a second associated time via zero or more other predetermined locations that may or may not have an associated time, the system including:
means for detecting the location of a transportation means in the network, and recording the time of that detection; and
a processing means for performing the method of claim 37 in response to a received query.

41. A system for determining if one or more objects could have been at a predetermined location during a predetermined time period, the system including:
at least one object detection computer processor and memory arranged to record the entry or exit of an object from the network, and the associated entry or exit time;
at least one object transportation computer processor and memory arranged to record the time of arrival, and the time of departure of a transportation means from each node;
a query computer processor and memory in communication with the at least one object detection computer processor and memory and the least one object transportation computer processor and memory for analysis of said records and receiving queries, wherein said query computer processor and memory performs the method of any one of claim 1,2, 3, 16, 28, 29, 30 or 33 in response to a received query.

42. A system as claimed in claim 41, wherein the object detection computer processor and memory are part of a ticketing system.

43. A system as claimed in claim 41, wherein the object detection computer processor and memory are part of a video surveillance system which monitors node entrances and exits.

44. A system for determining the feasibility of an object being able to transit from one predetermined location at an associated time to a second predetermined location at a second associated time via zero or more other predetermined locations that also have an associated time if one or more objects that could have been at a predetermined location during a predetermined time period, the system including:
at least one object transportation computer processor and memory arranged to record the time of arrival, and the time of departure of a transportation means from each node;
a query computer processor and memory in communication with the at least one object transportation computer processor and memory for analysis of said records and receiving queries, wherein said query computer processor and memory performs the method of claim 36 in response to a received query.

45. A system for determining the feasibility of an object being able to transit from one predetermined location at an associated time to a second predetermined location at a second associated time via zero or more other predetermined locations that may or may not have an associated time, the system including:
at least one object transportation computer processor and memory arranged to record the time of arrival, and the time of departure of a transportation means from each node;
a query computer processor and memory in communication with the at least one object transportation computer processor and memory for analysis of said records and receiving queries, wherein said query computer processor and memory performs the method of claim 37 in response to a received query.

46. A system as claimed in claim 41, 44 or 45, wherein the object transportation computer processor and memory are part of a network operations system.
